(19) United States
(12) Patent Application Publication
(10) Pub. No.: US 2025/0310691 A1
(43) Pub. Date: Oct. 2, 2025

(54) ELECTRONIC DEVICE INCLUDING SPEAKER

(71) Applicant: SAMSUNG ELECTRONICS CO., LTD., Suwon-si (KR)

(72) Inventors: Youngbae PARK, Suwon-si (KR); Myoungsung SIM, Suwon-si (KR); Myeungseon KIM, Suwon-si (KR); Taeeon KIM, Suwon-si (KR); Joonrae CHO, Suwon-si (KR); Chulmin CHOI, Suwon-si (KR)

(21) Appl. No.: 19/087,824

(22) Filed: Mar. 24, 2025

Related U.S. Application Data
(63) Continuation of application No. PCT/KR2025/095064, filed on Mar. 21, 2025.

(30) Foreign Application Priority Data
Apr. 1, 2024 (KR) 10-2024-0044250
Jun. 5, 2024 (KR) 10-2024-0073701

(51) Int. Cl. H04R 3/14; H04R 1/02; H04R 1/24; H04R 29/00

(52) U.S. Cl. CPC H04R 3/14; H04R 1/025; H04R 1/028; H04R 1/24; H04R 29/002; H04R 2430/01; H04R 2499/11; H04R 2499/15

(57) ABSTRACT

An electronic device includes an audio passage which is exposed to outside of the electronic device and along which a foreign substance is moveable, and a speaker in audio communication with the audio passage. The speaker is configured to simultaneously output a first sound corresponding to a first frequency range and a second sound corresponding to a second frequency range as a sound which is output into the audio passage. The speaker simultaneously outputting the first sound and the second sound both corresponds to the foreign substance being within the audio passage and moves the foreign substance which is within the audio passage along the audio passage and toward the outside of the electronic device.

### CROSS-REFERENCE TO RELATED APPLICATIONS

This application is a continuation application of International Application No. PCT/KR2025/095064 designating the United States, filed on Mar. 21, 2025, in the Korean Intellectual Property Receiving Office and claiming priority to Korean Patent Application No. 10-2024-0044250, filed on Apr. 1, 2024, and Korean Patent Application No. 10-2024-0073701, filed on Jun. 5, 2024, in the Korean Intellectual Property Office, the disclosures of which are incorporated by reference herein in their entireties.

### BACKGROUND

### (1) Field

The disclosure relates to an electronic device including a speaker.

### (2) Description of the Related Art

An electronic device may include a speaker and a sound passage formed around the speaker. A sound output from the speaker may be transmitted out of the electronic device through the passage.

When water flows into the sound passage, the electronic device may be configured to perform a function of removing water. For example, the electronic device may output a functional sound for removing water to remove water having flowed into the sound passage.

The above information is presented as background information only to assist with an understanding of the disclosure. No determination has been made, and no assertion is made, as to whether any of the above might be applicable as prior art with regard to the disclosure.

### SUMMARY

An electronic device according to an embodiment of the disclosure may include a housing and a plurality of speakers. The housing may include at least one passage. The plurality of speakers may be configured to output a sound to the outside of the electronic device through the at least one passage.

In an embodiment, the plurality of speakers may be configured to output a first sound corresponding to a first frequency range and a second sound corresponding to a second frequency range different from the first frequency range simultaneously, based on occurrence of an event for removing a foreign substance in the passage or in proximity to the speakers.

In an embodiment, the first frequency range may be associated with a resonance frequency of a first speaker of the plurality of speakers, and the second frequency range may be associated with a resonance frequency of a second speaker of the plurality of speakers.

An electronic device according to an embodiment of the disclosure may include a first speaker, a passage, a processor, and a memory. The passage may be formed around the first speaker. The memory may be operatively connected to the processor.

In an embodiment, the memory may store an instruction that, when executed by the processor, causes the electronic device to: output a first sound including a plurality of sub sounds with different frequencies in a first frequency range at a predetermined sound pressure through the first speaker, and temporarily increase sound pressures of the respective sub sounds included in the first sound in a predetermined order.

### BRIEF DESCRIPTION OF THE DRAWINGS

FIG. 1 is a block diagram of an electronic device in a network environment according to an embodiment;

FIG. 2 is a block diagram of an integrated intelligence system according to an embodiment;

FIG. 3 is a block diagram of an integrated intelligence system according to an embodiment;

FIG. 4A, FIG. 4B, and FIG. 4C illustrate an electronic device according to an embodiment of the disclosure;

FIG. 5A and FIG. 5B are exploded perspective views of an electronic device according to an embodiment of the disclosure;

FIG. 6A and FIG. 6B illustrate a speaker according to an embodiment of the disclosure;

FIG. 7A, FIG. 7B, FIG. 7C, and FIG. 7D illustrate an electronic device according to an embodiment of the disclosure;

FIG. 8A and FIG. 8B illustrate an electronic device according to an embodiment of the disclosure;

FIG. 9A and FIG. 9B illustrate an electronic device according to an embodiment of the disclosure;

FIGS. 10A to 10D illustrate a first sound according to an embodiment of the disclosure;

FIGS. 11A to 11D illustrate a second sound according to an embodiment of the disclosure;

FIG. 12A and FIG. 12B illustrate a sound pressure graph according to an embodiment of the disclosure;

FIG. 13 illustrates a sound signal output method according to an embodiment of the disclosure;

FIG. 14 illustrates a sound signal output method according to an embodiment of the disclosure;

FIG. 15 illustrates a sound signal output method based on detection of a foreign substance;

FIG. 16 illustrates a sound signal output method based on a surrounding environment;

FIG. 17 illustrates a sound signal output method based on a speaker state;

FIG. 18 illustrates an electronic device according to an embodiment of the disclosure;

FIG. 19A and FIG. 19B illustrate an electronic device according to an embodiment of the disclosure; and

FIG. 20A and FIG. 20B illustrate an electronic device according to an embodiment of the disclosure.

### DETAILED DESCRIPTION

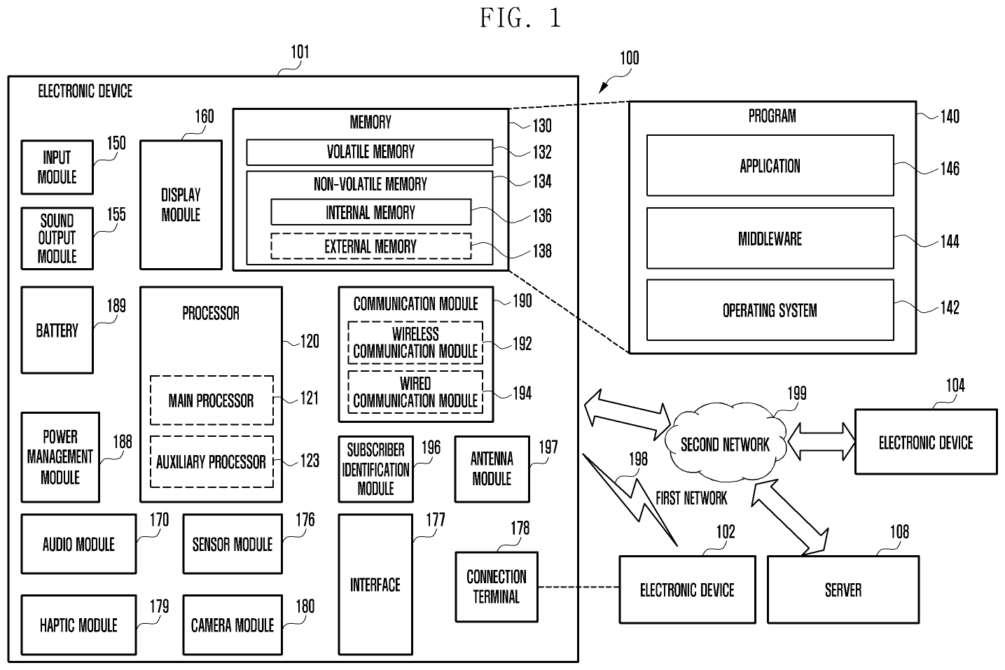

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

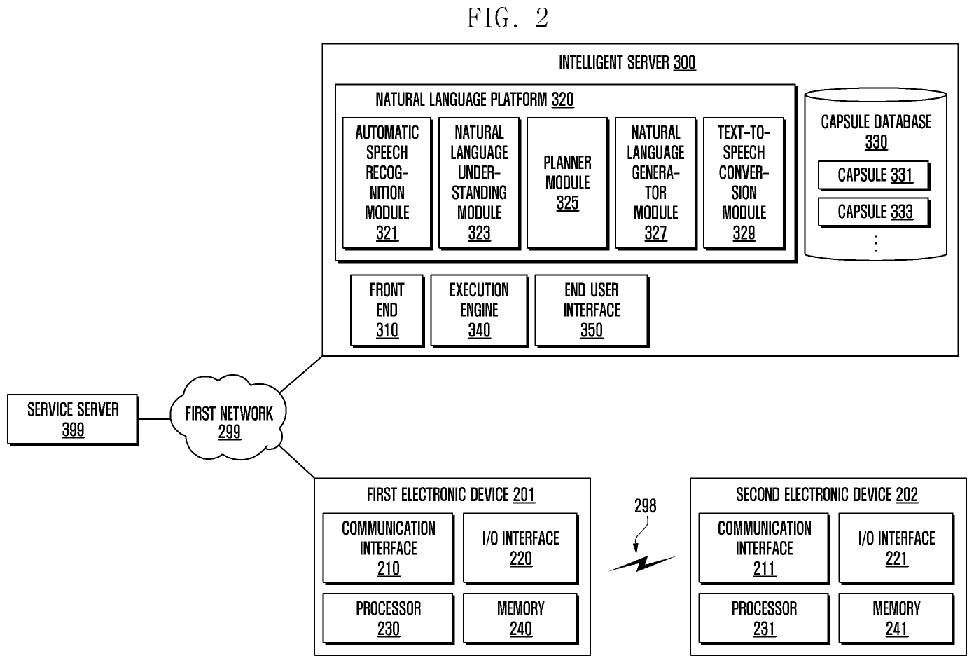

FIG. 2 is a block diagram illustrating an integrated intelligence system according to an embodiment.

Referring to FIG. 2, an integrated intelligent system according to an embodiment may comprise a first electronic device 201 (e.g., the electronic device 101 of FIG. 1), a second electronic device 202 (e.g., any device including a headset, earbuds, or a microphone), an intelligent server 300, and a service server 399.

According to the embodiment illustrated, the first electronic device 201 may comprise a communication interface 210, an input/output (I/O) interface 220, a processor 230, and/or a memory 240. The components enumerated above may be operatively or electrically coupled to each other. For example, the electronic device 201 may include at least some of the components of the electronic device 101 of FIG. 1.

The communication interface 210 may be connected to an external device (e.g., the intelligent server 300 and/or the service server 399) via a first network 299 (e.g., any network including a cellular network and/or a wireless local area network (WLAN)) to send and receive data. For example, the communication interface 210 may correspond to a communication module 190 of FIG. 1. The communication interface 210 may support sending and receiving data to and from an external device (e.g., the second electronic device 202) via a second network 298 (e.g., a short-range wireless communication network).

The I/O interface 220 may use input/output devices (not shown) (e.g., a microphone, a speaker, and/or a display (e.g., the display 160 in FIG. 1)) to receive a user input, process the received user input, and/or output a result of processing by the processor 230.

The processor 230 may be operatively or electrically coupled to the communication interface 210, the I/O interface 220, and/or the memory 240 (e.g., the memory 130 of FIG. 1) to perform specified operations. For example, the processor 230 may correspond to the processor 120 of FIG. 1. The processor 230 may execute a program (or one or more instructions) stored in the memory 240 to perform a specified action. For example, the processor 230 may receive a voice input (e.g., user's utterance) from a user via the I/O interface 220. For example, the processor 230 may receive, from the second electronic device 202, the user's voice input received by the second electronic device 202, via the communication interface 210. The processor 230 may transmit the received voice input via the communication interface 210 to the intelligent server 300. For example, the processor 230 may include one or more processors.

The processor 230 may receive a result corresponding to the voice input from the intelligent server 300. For example, the processor 230 may receive from the intelligent server 300 a plan corresponding to the voice input and/or a result calculated using the plan. For example, the plan may include information about a plurality of sequential operations to be executed by the first electronic device 201 and/or another electronic device in relation to the voice input, but the disclosure is not limited thereto. The processor 230 may receive a request from the intelligent server 300 to obtain information (e.g., entities, slots, and/or parameters) necessary to generate a plan corresponding to the voice input. The processor 230 may transmit the necessary information to the intelligent server 300 in response to the request.

The processor 230 may visually, tactilely, and/or audibly output the result of executing the specified operation according to the plan via the I/O interface 220. For example, the processor 230 may sequentially display the results of executing a plurality of operations on the display. In one example, the processor 230 may display only the result of executing the plurality of actions (e.g., the results of executing one of the plurality of actions or the last action). The processor 230 may transmit the execution result of the plurality of operations, or the execution results of at least some of the plurality of operations, to the second electronic device 202 to provide feedback via the second electronic device 202.

The processor 230 may recognize a voice input. For example, the processor 230 may execute an intelligent app (or a voice recognition app) for processing the voice input in response to the specified voice input (e.g., ‘Wake Up!’). The processor 230 may provide a speech recognition service via the intelligent app. The processor 230 may transmit the voice input to the intelligent server 300 via the intelligent app, and may receive a result corresponding to the voice input from the intelligent server 300.

According to one example, the second electronic device 202 may comprise a communication interface 211, an input/output (I/O) interface 221, a processor 231, and/or a memory 241. The components enumerated above may be operatively or electrically coupled to each other. In one example, the second electronic device 202 may be a set of multiple electronic devices configured into one set (e.g., a left earbud and a right earbud).

The communication interface 211 may support connectivity with an external device (e.g., the first electronic device 201) via the second network 298. The I/O interface 221 may utilize input/output devices (not shown) (e.g., at least one microphone, at least one speaker, and/or buttons) to receive a user input, process the received user input, and/or output a result of processing by the processor 231.

The processor 231 may be operatively and/or electrically coupled to the communication interface 211, the I/O interface 221, and/or the memory 241 to perform specified operations. The processor 231 may execute a program (or one or more instructions) stored in the memory 241 to perform the specified operation. For example, the processor 231 may receive a voice input (e.g., user's utterance) from a user via the I/O interface 221. In one example, the processor 231 may perform voice activity detection (VAD) using at least one sensor (not shown) of the second electronic device 202. The processor 231 may use an acceleration sensor and/or a microphone to detect user's utterance of the second electronic device 202.

The processor 231 may transmit the received voice input via the second network 298 to the first electronic device 201, using the communication interface 211.

The processor 231 may receive the result corresponding to the voice input from the first electronic device 201. For example, the processor 231 may receive, from the first electronic device 201, data (e.g., text data) corresponding to the result corresponding to the voice input. The processor 231 may output the received result via the I/O interface 221.

The processor 231 may recognize the voice input. For example, the processor 231 may request the first electronic device 201 to execute an intelligent app (or a voice recognition app) for processing the voice input in response to the specified voice input (e.g., ‘Wake up!’).

The intelligent server 300 according to an embodiment may receive the user's voice input from the first electronic device 201 via the first network 299. The intelligent server 300 may convert audio data corresponding to the received voice input into text data. Based on the text data, the intelligent server 300 may generate at least one plan for performing a task corresponding to the user's voice input. The intelligent server 300 may transmit the generated plan, or a result according to the generated plan, to the first electronic device 201 via the first network 299.

The intelligent server 300 according to an embodiment may execute one or more programs including a front end 310, a natural language platform 320, a capsule database 330, an execution engine 340, and/or an end user interface 350.

The front end 310 may receive the voice input, from the first electronic device 201, received by the first electronic device 201 or the second electronic device 202. The front end 310 may transmit a response corresponding to the voice input to the first electronic device 201.

The natural language platform 320 may comprise an automatic speech recognition (ASR) module 321, a natural language understanding (NLU) module 323, a planner module 325, a natural language generator (NLG) module 327, and/or a text-to-speech (TTS) conversion module 329.

The automatic speech recognition module 321 may convert the voice input received from the first electronic device 201 into text data. The natural language understanding module 323 may identify a user's intent and/or parameters (e.g., entities and/or slots) based on the text data of the voice input. The user's intent corresponds to the voice input and may include information indicating an action (or function) that the user wishes to perform using the device. The slot may be detail information associated with the user's intent. The slot may be obtained based on a domain corresponding to the user's utterance. The slot may be variable information that is required to perform the action. In one embodiment, the variable information configuring the slot may include a named entity.

The planner module 325 may generate a plan using the intent and/or parameters determined by the natural language understanding module 323. For example, the planner module 325 may determine at least one domain required to perform a task based on the determined intent. The domain may correspond to a category (or service) associated with actions (or functions) that the user wishes to perform using the device. The domain may be categorized according to the service (e.g., app) related to the text. The domain may be associated with the user's intent corresponding to the text. The domains may be categorized, for example, according to the application that received the voice input and/or the kind of service to be provided based on the voice input, but the disclosure is not limited thereto. In one example, the determination of the domain may be performed by another module (e.g., the natural language understanding module 323). The planner module 325 may determine a plurality of actions included in each of the at least one domains determined based on the intent. The planner module 325 may determine parameters required to execute the determined plurality of behaviors, or resultant values output by the execution of the plurality of actions. The parameters and the resultant values may be defined as concepts of a specified type (or class). For example, the plan may include a plurality of actions and/or a plurality of concepts determined by the user intent. The planner module 325 may determine relationships between the plurality of actions and/or the plurality of concepts in a stepwise (or hierarchical) manner. For example, the planner module 325 may identify a sequence of execution of the plurality of actions (e.g., a plurality of actions determined based on the user's intent) based on the plurality of concepts (e.g., parameters required for execution of the plurality of actions, and results output by execution of the plurality of actions). The planner module 325 may generate a plan that includes association information (e.g., ontology) between the plurality of actions and the plurality of concepts. The planner module 325 may generate the plan using information (e.g., at least one capsule) stored in the capsule database 330 in which a set of relationships between concepts and actions is stored.

The planner module 325 may generate a plan based on an artificial intelligence (AI) system. For example, the AI system may comprise one or more electronic devices, and/or one or more processing circuitries to execute a rule-based function, a neural network-based function (e.g., a feedforward neural network (FNN), and/or a recurrent neural network (RNN)), or a combination thereof. The artificial intelligence system described above is only of an example, and the artificial intelligence system may be an artificial intelligence system based on any model based on machine learning. The planner module 325 may select a plan corresponding to the user's request from a set of predefined plans, or may generate a plan in real time in response to the user's request.

The natural language generator module 327 may change specified information into a textual form. The textualized information may be in the form of a natural language utterance. The text-to-speech conversion module 329 may convert a textual form of information into a speech form of information.

The capsule database 330 may store information about the relationship of a plurality of concepts and actions corresponding to a plurality of domains (e.g., applications). The capsule database 330 may store at least one capsule (e.g., a capsule 331 and/or a capsule 333) in the form of a concept action network (CAN). For example, the capsule database 330 may store, in the form of CAN, an action for processing a task corresponding to the user's voice input, and/or parameters required for the action. The capsule may include a plurality of action objects (or action information) and/or concept objects (or concept information) included in the plan. For example, the capsules (331, 333) may be generated per domain and stored in capsule database 330, but the present disclosure is not limited thereto.

The execution engine 340 may utilize the generated plan to produce a result. The end user interface 350 may transmit the produced result to the first electronic device 201.

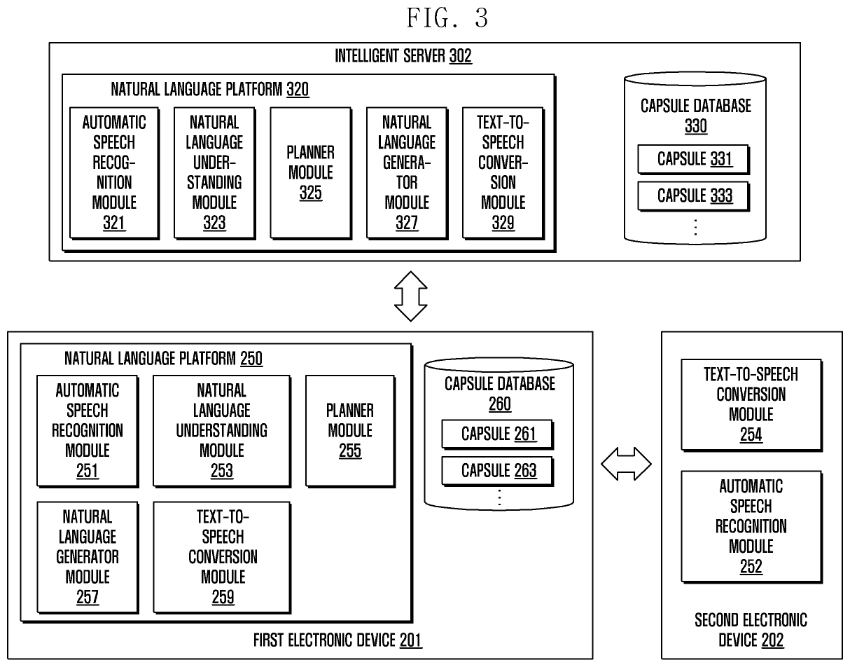

According to an embodiment, some functionality of the intelligent server 300 (e.g., the natural language platform 320) or the entire functionality thereof may be implemented in the first electronic device 201. For example, the first electronic device 201 may execute one or more programs including a natural language platform (e.g., the natural language platform 250 of FIG. 3) separate from the intelligent server 300. For example, the electronic device 201 may directly perform at least some of the operations of the natural language platform 320 of the intelligent server 300 (e.g., the automatic speech recognition module 321, the natural language understanding module 323, the planner module 325, the natural language generator module 327, and/or the text-to-speech conversion module 329).

The service server 399 according to an embodiment may provide a specified service (e.g., ordering food or making a hotel reservation) to the first electronic device 201. The service server 399 may be a server operated by an operator different from that of the intelligent server 300. The service server 399 may communicate with the intelligent server 300 and/or the first electronic device 201 via the first network 299. The service server 399 may communicate with the intelligent server 300 over a separate connection (untouched). The service server 399 may provide the intelligent server 300 with information (e.g., action information and/or concept information for providing a specified service) for generating a plan corresponding to the voice input received by the first electronic device 201. The information provided may be stored in the capsule database 330. The service server 399 may provide the intelligent server 300 with resultant information according to the plan, received from the first electronic device 201.

FIG. 3 is a block diagram illustrating an integrated intelligence system according to an embodiment.

Referring to FIG. 3, the integrated intelligence system may comprise a first electronic device 201, a second electronic device 202, and an intelligent server 302. The first electronic device 201 and the intelligent server 302 may be connected to each other over a network to send and receive data. The first electronic device 201 and the second electronic device 202 may be connected to each other via a local area network to send and receive data. According to an embodiment, the integrated intelligence system may comprise a single device or a plurality of devices. For example, each device may include a configuration of the same or similar functionality, and a configuration of one device may be substituted with a configuration of another device.

According to an embodiment, the intelligent server 302 may include the entire configuration or at least part of the configuration of the intelligent server 300 illustrated in FIG. 2. For example, the intelligent server 302 may execute one or more programs including the natural language platform 320 and/or may store the capsule database 330 of the intelligent server 300 of FIG. 2. The configuration of the intelligent server 302 is not limited to that illustrated in FIG. 3. For example, at least some configuration of the natural language platform 320 (e.g., the automatic speech recognition module 321, the natural language understanding module 323, the planner module 325, the natural language generator module 327, and/or the text-to-speech conversion module 329) may be omitted from the intelligent server 302. For example, the intelligent server 302 may further comprise some configuration of the intelligent server 300 of FIG. 2 (e.g., the front end 310, the execution engine 340, and/or the end user interface 350).

The first electronic device 201 may execute one or more programs including a natural language platform 250 and/or may store a capsule database 260. For example, the first electronic device 201 may further execute one or more programs including a natural language platform 250 and/or may store a capsule database 260, while including the components of the first electronic device 201 of FIG. 2.

The natural language platform 250 may comprise an automatic speech recognition module 251, a natural language understanding module 253, a planner module 255, a natural language generator module 257, and/or a text-to-speech conversion module 259. The automatic speech recognition module 251, the natural language understanding module 253, the planner module 255, the natural language generator module 257, and the text-to-speech conversion module 259 may each perform the same or similar functions as the automatic speech recognition module 321, the natural language understanding module 323, the planner module 325, the natural language generator module 327, and the text-to-speech conversion module 329 of FIG. 2.

The capsule database 260 may perform the same or similar function as the capsule database 330 of the intelligent server (300, 302). The capsule database 260 may store information about relationships of a plurality of actions and a plurality of concepts included in a plan generated by the planner module 255. For example, the capsule database 260 may store at least one capsule (e.g., capsule 261 and/or capsule 263).

According to an embodiment, the first electronic device 201 (e.g., the natural language platform 250) and/or the capsule database 260) and the intelligent server 302 (e.g., the natural language platform 320 and/or the capsule database 330) may perform at least one function (or action) in conjunction with each other, or each may perform the at least one function (or action) independently from each other. For example, the first electronic device 201 may perform speech recognition on its own, without transmitting the received user's voice input to the intelligent server 302. In one example, the first electronic device 201 may convert the received voice input into text data via the automatic voice recognition module 251. The first electronic device 201 may transmit the converted text data to the intelligent server 302. The intelligent server 302 may determine (or identify) the user's intent and/or parameters from the text data via the natural language understanding module 323. The intelligent server 302 may generate a plan through the planner module 325 based on the determined intent and parameters to transmit the same to the first electronic device 201, or may transmit the determined intent and parameters to the first electronic device 201 to generate a plan through the planner module 255 of the first electronic device 201. The planner module 255 of the first electronic device 201 may use the information stored in the capsule database 260 to generate at least one plan for performing a task corresponding to the voice input.

As an example, the first electronic device 201 may convert the received voice input into text data through the automatic speech recognition module 251, and determine (or identify) the user's intent and/or parameters based on the text data through the natural language understanding module 253. The first electronic device 201 may generate a plan through the planner module 255 based on the determined intent and parameters, or may transmit the determined intent and parameters to the intelligent server 302 to generate a plan through the planner module 225 of the intelligent server 302. For example, in case that the planner module 255 and/or the capsule database 260 is not stored in the first electronic device 201, the first electronic device 201 may generate the plan through the intelligent server 302.

In an example, the first electronic device 201 may detect an utterance pattern that is difficult to learn from the automatic speech recognition module 251 or the natural language understanding module 253, and transmit the voice input corresponding to the detected utterance pattern to the intelligent server 302 for processing by the automatic speech recognition module 321 or the natural language understanding module 323 of the intelligent server 302.

Embodiments of the disclosure are not limited to the examples described above. For example, the first electronic device 201 may process the received voice input only within a terminal to produce a result corresponding to the voice input. As an example, the first electronic device 201 and the intelligent server 302 may not only process the voice input by segmenting the same into the units of modules, but also process the same in collaboration between the corresponding modules. For example, the natural language understanding module 253 of the first electronic device 201 and the natural language understanding module 323 of the intelligent server 302 may work together to produce one resultant value (e.g., the user' intent and/or parameters).

The second electronic device 202 may execute one or more programs including an automatic speech recognition (ASR) module 252 and/or a text to speech (TTS) conversion module 254. For example, the second electronic device 202 may execute one or more programs including an automatic speech recognition module 252 and/or a text to speech module 254, while including the components of the second electronic device 202 of FIG. 2. The automatic speech recognition module 252 and the text-to-speech module 254 may perform the same or similar functions as the automatic speech recognition module 321 and the text-to-speech conversion module 329 of FIG. 2, respectively.

According to an embodiment, the first electronic device 201 and the second electronic device 202 may perform at least one function (or operation) in conjunction with each other, or each may perform the at least one function (or operation) independently. For example, the second electronic device 202 may perform speech recognition of a voice input using the automatic speech recognition module 252. The second electronic device 202 may perform a function corresponding to the voice input based on the speech recognition. For example, the second electronic device 202 may transfer a command corresponding to the recognized voice command to the first electronic device 201. The second electronic device 202 may output data received from the first electronic device 201. For example, the second electronic device 202 may convert the data received from the first electronic device 201 into speech using the text-to-speech conversion module 254, and output the converted speech.

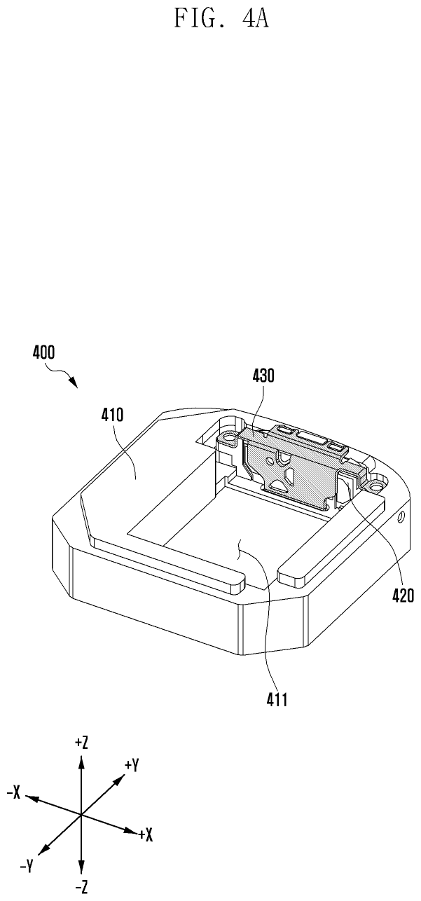

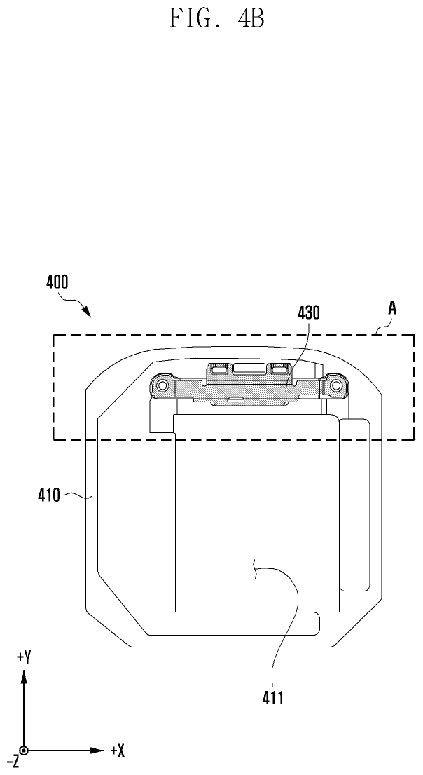

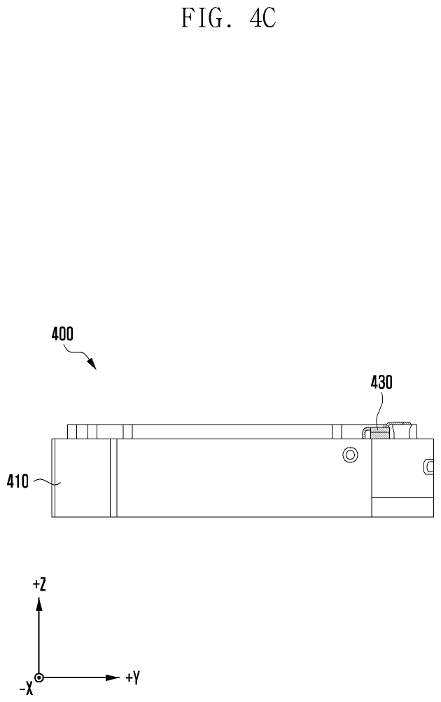

FIG. 4A, FIG. 4B, and FIG. 4C illustrate an electronic device 400 according to an embodiment of the disclosure.

FIG. 4A is a perspective view of the electronic device 400 according to an embodiment. FIG. 4B is a plane (or plan) view of the electronic device 400 according to an embodiment. FIG. 4C is a lateral (or cross-sectional) view of the electronic device 400 according to an embodiment.

In describing the electronic device 400 according the embodiment of the disclosure, the length direction of the electronic device 400 may denote an x-axis direction. The width direction of the electronic device 400 may denote a y-axis direction. The height direction of the electronic device 400 may denote a z-axis direction. A thickness (or height) of the electronic device 400 and/or various components thereof, may be represented by the z-axis direction.

In an embodiment, the electronic device 400 may refer to the electronic device 101 of FIG. 1, or may include at least some of the components of the electronic device 101 of FIG. 1.

In an embodiment, the electronic device 400 may mean the first electronic device 201 of FIG. 2 and FIG. 3, or may include at least some of the components of the first electronic device 201 of FIG. 2 and FIG. 3.

In an embodiment, the electronic device 400 may refer to the second electronic device 202 of FIG. 2 and FIG. 3, or may include at least some of the components of the second electronic device 202 of FIG. 2 and FIG. 3

In an embodiment, the electronic device 400 may be a wearable electronic device which is attachable to and detachable from a body part of a user using the electronic device 400.

The electronic device 400 according to an embodiment of the disclosure may include a housing 410, a speaker unit 420, and/or a support member 430.

In an embodiment, the housing 410 may include (or define) a first space 411 in which an electronic component (e.g., a printed circuit board or a battery) may be disposed.

In an embodiment, the speaker unit 420 may be disposed in at least a portion of the housing 410.

In an embodiment, the support member 430 may be disposed to cover at least a portion of the speaker unit 420. For example, the speaker unit 420 may be secured to the housing 410 by the support member 430. In an embodiment, the support member 430 may be a bracket for securing the speaker unit 420 to the housing 410.

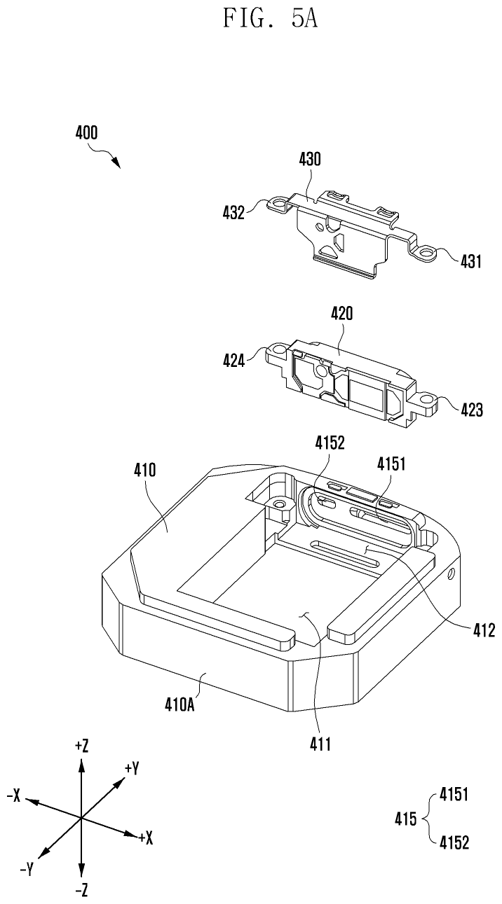

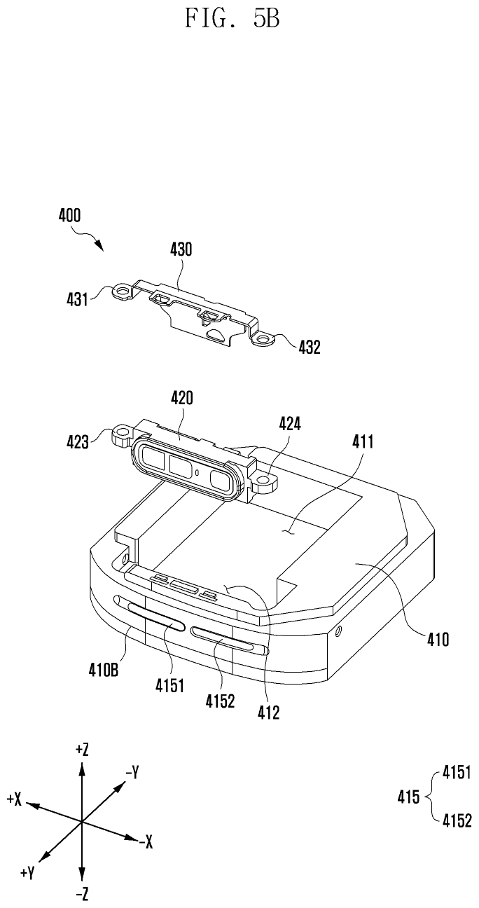

FIG. 5A and FIG. 5B are exploded perspective views of an electronic device 400 according to an embodiment of the disclosure.

FIG. 5A is an exploded perspective view illustrating a first surface 410A of a housing 410 of the electronic device 400 according to an embodiment. FIG. 5B is an exploded perspective view illustrating a second surface 410B of the housing 410 of the electronic device 400 according to an embodiment. The first surface 410A and the second surface 410B may each be an outer surface of the electronic device. The first surface 410A and the second surface 410B may represent a rear surface and a front surface, respectively, of the electronic device 400.

The electronic device 400 according to an embodiment of the disclosure may include the housing 410, a speaker unit 420, and/or a support member 430.

In an embodiment, a portion of the housing 410, the speaker unit 420, and the support member 430 may be stacked. For example, the speaker unit 420 may be disposed in the housing 410, and the support member 430 may be disposed on the speaker unit 420. Here, the portion of the housing 410, the speaker unit 420 and the support member 430 may be in order in a direction from the front of the electronic device 400.

In an embodiment, the housing 410 may include a first space 411, a second space 412, and/or a passage 415 as an audio passage. The second space 412 may correspond to planar area or volume occupied by the speaker unit 420, without being limited thereto. Each of the first space 411, the second space 412 and the passage 415 may represent a volume which is defined by portions of the housing 410. The various spaces and passages described herein may be empty spaces or empty volumes at an inner area of the housing 410.

In an embodiment, the second space 412 may be a space disposed in one direction (e.g., in the +y-axis direction) of the first space 411. In an embodiment, the second space 412 may be connected to the first space 411. That is, the first space 411 (e.g., a first inner space) together with the second space 412 (e.g., a second inner space) may together define an inner space (e.g., an inner volume) of the housing 410.

In an embodiment, the speaker unit 420 may be disposed in the second space 412.

In an embodiment, the speaker unit 420 may be disposed in the second space 412 to face the passage 415.

In an embodiment, the passage 415 may be a passageway for transmitting a sound output from the speaker unit 420 to the outside of the electronic device 400. The passage 415 may represent an acoustic passage through which an audio signal or sound passes from the inside of the housing 410 (or electronic device 400) to the outside of the housing 410 (or the electronic device 400).

In an embodiment, the passage 415 may include a first passage 4151 and/or a second passage 4152. The passage 415 may be open toward the second space 412, such that the speaker unit 420 which is inside the second space 412 faces the passage 415. Each of the first passage 4151 and the second passage 4152 may be exposed to the speaker unit 420 at the inner space of the housing 410.

In an embodiment, the first passage 4151 and the second passage 4152 may be formed to penetrate the second surface 410B of the housing 410. Each of the first passage 4151 and the second passage 4152 may be exposed to outside of the housing 410 at locations where the passage 415 penetrates the outer surface of the housing 410. For example, FIG. 5B shows a penetration (e.g., a through-hole or opening) in the housing 410 at which the first passage 4151 and the second passage 4152 are exposed to outside the housing 410.

In an embodiment, the speaker unit 420 may include a first fixing unit 423 and/or a second fixing unit 424.

In an embodiment, the first fixing unit 423 may be formed (or provided) at one end portion (e.g., a first end portion) of the speaker unit 420 along a length (e.g., a major dimension) thereof), and the second fixing unit 424 may be formed at the other end portion (e.g., a second end portion which is opposite to the first end portion along the length) of the speaker unit 420.

In an embodiment, the first fixing unit 423 and the second fixing unit 424 may be parts of the speaker unit 420 which are fixed to the housing 410.

In an embodiment, the speaker unit 420 may be coupled to the housing 410 at least in part. For example, the speaker unit 420 may be coupled to the housing 410 at the first fixing unit 423 and/or the second fixing unit 424. That is, the speaker unit 420 may be fixed to the housing 410 at one or more end among opposing ends of the speaker unit 420, without being limited thereto.

In an embodiment, the support member 430 may include a third fixing unit 431 and/or a fourth fixing unit 432.

In an embodiment, the third fixing unit 431 may be formed at one end portion of the support member 430, and the fourth fixing unit 432 may be formed at the other end portion of the support member 430.

In an embodiment, the support member 430 may be at least partly coupled with the speaker unit 420. For example, the third fixing unit 431 of the support member 430 may be coupled with the speaker unit 420 at the first fixing unit 423 thereof. The fourth fixing unit 432 of the support member 430 may be coupled with the speaker unit 420 at the second fixing unit 424 thereof.

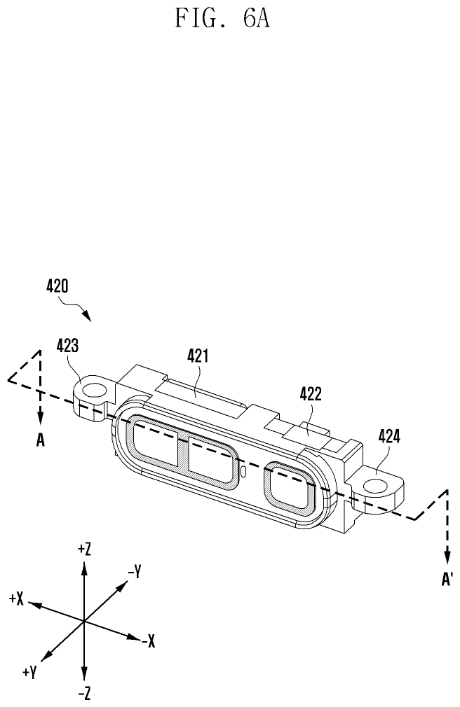

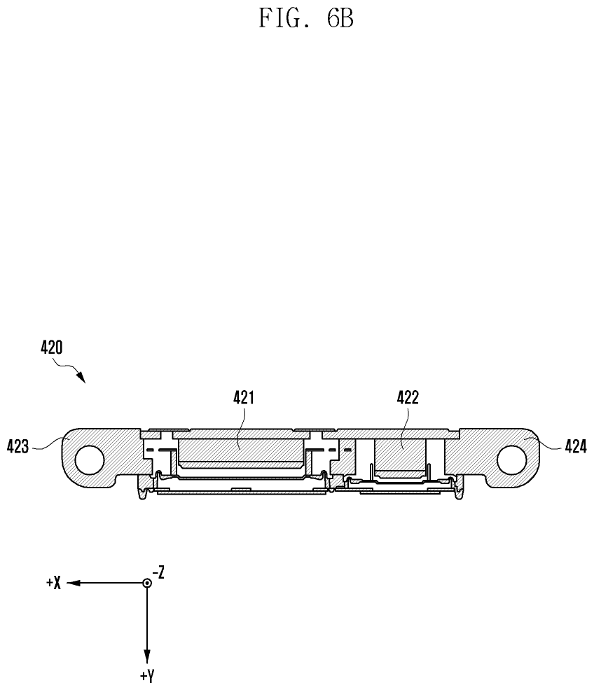

FIG. 6A and FIG. 6B illustrate a speaker unit 420 according to an embodiment of the disclosure.

FIG. 6A is a perspective view illustrating the speaker unit 420 according to an embodiment. FIG. 6B is a plan view of the speaker unit 420 along line A-A′ of FIG. 6A.

In an embodiment, the speaker unit 420 may include a speaker provided in plural such as a first speaker 421 and a second speaker 422, and one or more of a fixing member such as a first fixing unit 423 and/or a second fixing unit 424.

In an embodiment, the speaker unit 420 may include a plurality of speakers. For example, referring to FIG. 6A and FIG. 6B, the speaker unit 420 may include the first speaker 421 and the second speaker 422.

In an embodiment, the second speaker 422 may be a different speaker from the first speaker 421. For example, the second speaker 422 may be a separate speaker distinct from the first speaker 421, such that the speakers may operate or be controlled independently to output different sounds or same sounds, at a same time (e.g., simultaneously) or at different times.

In an embodiment, the speaker unit 420 may be formed to include two different speakers. For example, the speaker unit 420 may include the first speaker 421 and the second speaker 422 which is different from the first speaker 421.

In an embodiment, the first speaker 421 may be a main speaker for basic sound output of the electronic device 400. The second speaker 422 may be an auxiliary speaker for assisting the sound output of the first speaker 421.

Although FIG. 6A and FIG. 6B shows that the speaker unit 420 includes two speakers, the number of speakers included in the speaker unit 420 may not be limited thereto. For example, the speaker unit 420 may include three or more speakers.

In an embodiment, the speaker unit 420 may include a micro speaker, a piezo speaker, and/or a micro-electromechanical systems (MEMS) speaker.

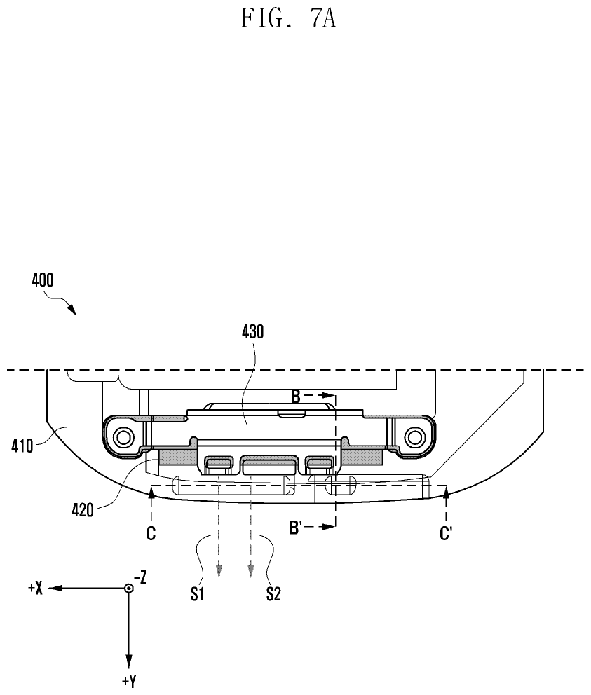

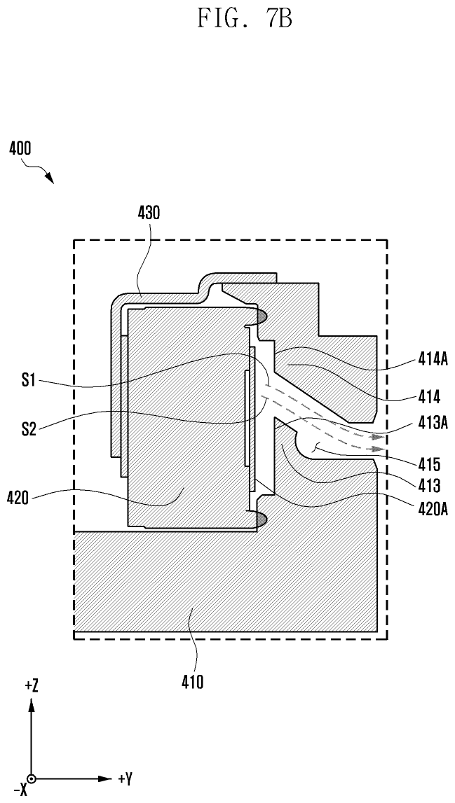

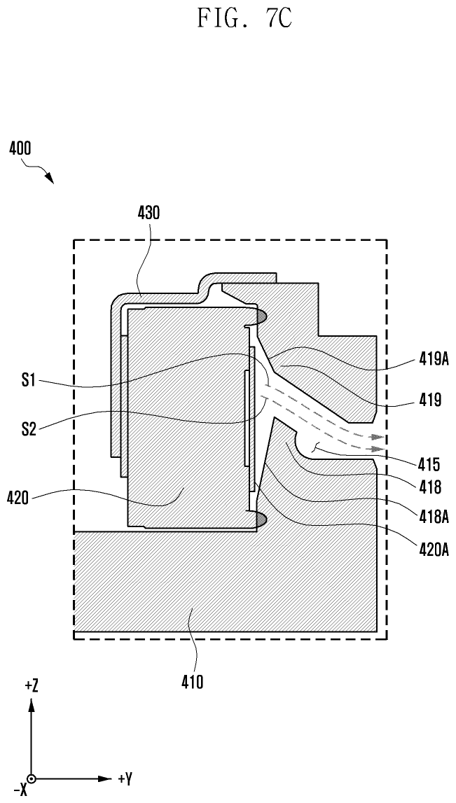

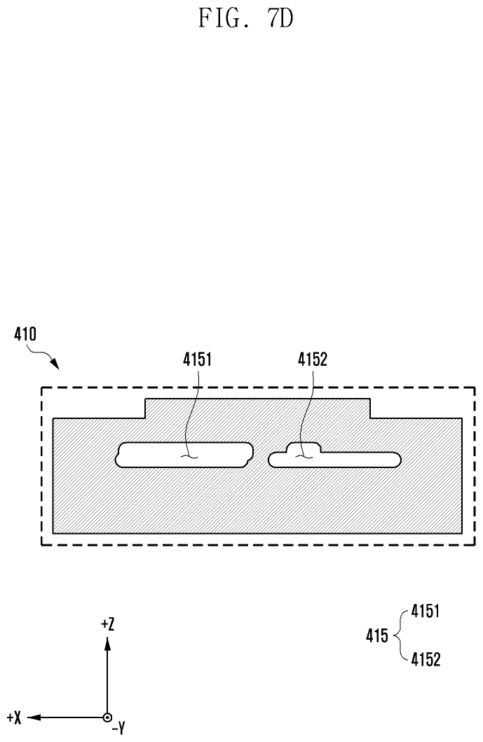

FIG. 7A, FIG. 7B, FIG. 7C, and FIG. 7D illustrate an electronic device 400 according to an embodiment of the disclosure.

FIG. 7A is an enlarged plan view of area A illustrated in FIG. 4B. FIG. 7B and FIG. 7C are enlarged cross-sectional views which illustrate the electronic device 400 viewed along line B-B′ of FIG. 7A. FIG. 7D illustrates a cross-sectional view of the electronic device 400 along line C-C′ of FIG. 7A.

In an embodiment, the speaker unit 420 may be disposed in the housing 410. In an embodiment, the support member 430 may be disposed to cover at least a portion of the speaker unit 420, at an inner side of the electronic device 400.

Referring to FIG. 7A and FIG. 7B, the speaker unit 420 according to an embodiment may be disposed to face the passage 415. That is, a speaker output at which a sound is output from the speaker unit 420 may face a passage inlet of the passage 415. A sound output from the speaker unit 420 may enter into the passage 415 through the inlet thereof, travel through the passage 415 along a length of the passage 415 (e.g., along a flow direction from inside the electronic device 400 to outside thereof) and be transmitted through a passage outlet to the outside of the electronic device 400.

In an embodiment, the housing 410 may include a partition wall 413 formed around the passage 415. For example, referring to FIG. 7A and FIG. 7B, the partition wall 413 may be formed such that a portion of the housing 410 protrudes in a direction toward the passage 415 (e.g., in the +z-axis direction) to define the partition wall 413. Facing portions of the housing 410 may define the passage 415 therebetween.

In an embodiment, the partition wall 413 may serve to prevent impact from being applied to the speaker unit 420. For example, the partition wall 413 may serve to prevent or reduce an object which is located outside the electronic device 400 and foreign to the electronic device 400 (e.g., a foreign object), from moving toward the speaker unit 420 through the passage 415.

In an embodiment, a surface 413A (e.g., an inner surface) of the partition wall 413 which faces the speaker unit 420 may be formed substantially parallel to one surface 420A (e.g., an outer surface) of the speaker unit 420. For example, referring to FIG. 7B, the surface 413A of the partition wall 413 according to an embodiment may be formed substantially parallel to the surface 420A of the speaker unit 420. The outer surface of the speaker unit 420 which faces the inner surface of the partition wall 413 may represent an audio output or audio output surface of the speaker unit 420, without being limited thereto.

The housing 410 according to an embodiment may include a lateral portion 414 spaced apart from the partition wall 413 in the height direction (e.g., in the z-axis direction) and facing the speaker unit 420. In an embodiment, one surface 414A (e.g., an inner surface) of the lateral portion 414 may be formed substantially parallel to the one surface 420A of the speaker unit 420. The surfaces 413A and 414A of the housing 410 may together define an inner surface portion of the housing 410 at which the passage 415 is open to the speaker unit 420. That is, the surfaces 413A and 414A which are spaced apart from each other may define an audio inlet of the passage 415.

In an embodiment, the electronic device 400 may include the partition wall 413 formed in or by the housing 410, thus preventing or reducing inflow of a foreign substance into the electronic device 400.

FIG. 7C may illustrate the electronic device 400 including a partition wall 418 having a different shape from that in FIG. 7B.

In the electronic device 400 according to an embodiment, one surface 418A of the partition wall 418 may be formed inclined based on one surface 420A of the speaker unit 420. The one surface 418A may be inclined in a direction away from the speaker unit 420. For example, referring to FIG. 7C, the surface 420A of the speaker unit 420 may be formed substantially parallel to the z-axis direction, and the surface 418A of the partition wall 418 may be formed substantially parallel to a direction inclined at a predetermined angle based on the z-axis direction. Referring to FIG. 7C, the surface 418A of the partition wall 418 may be formed such that the distance from the surface 420A of the speaker unit 420 to an inner surface of the housing 410 at the surface 418A, increases in the +z-axis direction.

In the electronic device 400 according to an embodiment, one surface 419A of a lateral portion 419 may be formed inclined based on the surface 420A of the speaker unit 420. For example, referring to FIG. 7C, the surface 420A of the speaker unit 420 may be formed substantially parallel to the z-axis direction, and the surface 419A of the lateral portion 419 may be formed substantially parallel to a direction inclined at a predetermined angle based on the z-axis direction. Referring to FIG. 7C, the surface 419A of the lateral portion 419 may be formed such that the distance from the surface 420A of the speaker unit 420 to an inner surface of the housing 410 at the surface 419A, increases in the −z-axis direction.

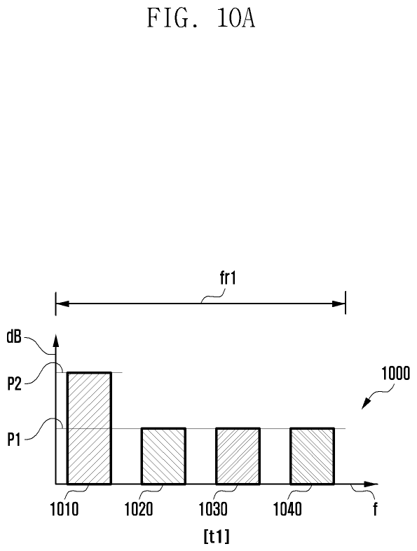

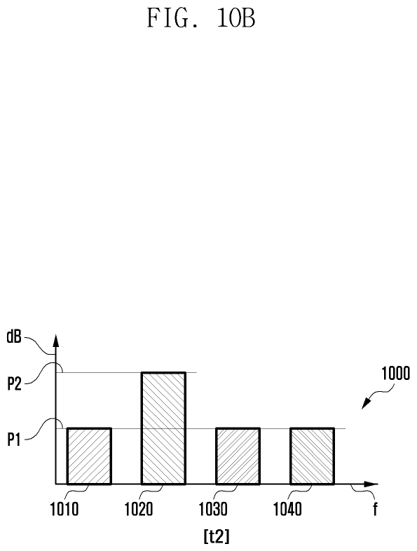

In the electronic device 400 according to an embodiment, when the surface 418A of the partition wall 418 and/or the surface 419A of the lateral portion 419 are formed in an inclined shape based on the surface 420A of the speaker unit 420, a foreign object or a foreign substance (e.g., water) having flowed into a space (or volume) between the speaker unit 420 and the partition wall 418 and/or between the speaker unit 420 and the lateral portion 419 may be easily discharged to the outside of the electronic device 400. For example, when the surface 418A of the partition wall 418 is formed in an inclined shape, water moved by a sound (e.g., a first sound 1000 of FIGS. 10A to 10D) may be easily moved to the outside of the electronic device 400, such as through vibration or a percussive force of the sound which act on the foreign object and/or inner components of the electronic device 400 to move the foreign object. The discharge and/or movement of the foreign object to outside of the electronic device 400 may flow along the passage 415 to be output from the electronic device 400. Further, when the surface 418A of the partition wall 418 is formed in an inclined shape, water having flowed into the electronic device 400 may be easily evaporated by heat.

In an embodiment, at least one passage 415 may be formed in the housing 410. For example, referring to FIG. 7D, the passage 415 may include a first passage 4151 as a first sub-passage and/or a second passage 4152 as a second sub-passage. In FIG. 7D, for example, respective outlets of the first and second sub-passages may be spaced apart from each other along an outer surface of the electronic device 400.

In an embodiment, the first passage 4151 and the second passage 4152 may each correspond to at least a portion of the speaker unit 420. For example, the first passage 4151 may be a passage corresponding to a first speaker 421 (see FIG. 6B). The second passage 4152 may be a passage corresponding to a second speaker 422 (see FIG. 6B). Audio inlets of the first passage 4151 and the second passage 4152 may respectively correspond to or be in respective audio communication with the first speaker 421 and the second speaker 422,

Referring to FIG. 7A, FIG. 7B, and FIG. 7C, two different sounds S1 and S2 may be output simultaneously from the speaker unit 420. For example, a first sound S1 and/or a second sound S2 may be output simultaneously from a same speaker such as the first speaker 421 (see FIG. 6B) of the speaker unit 420.

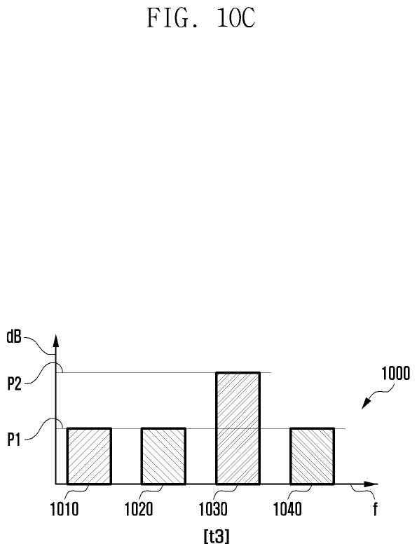

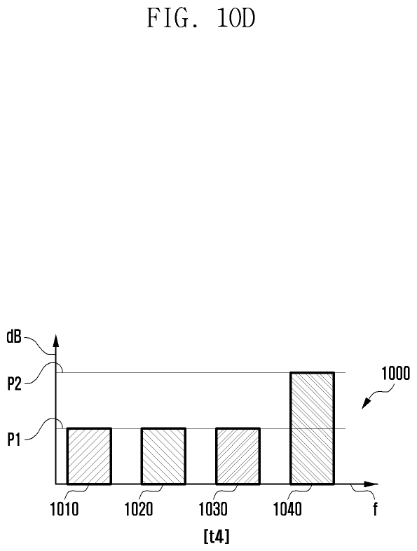

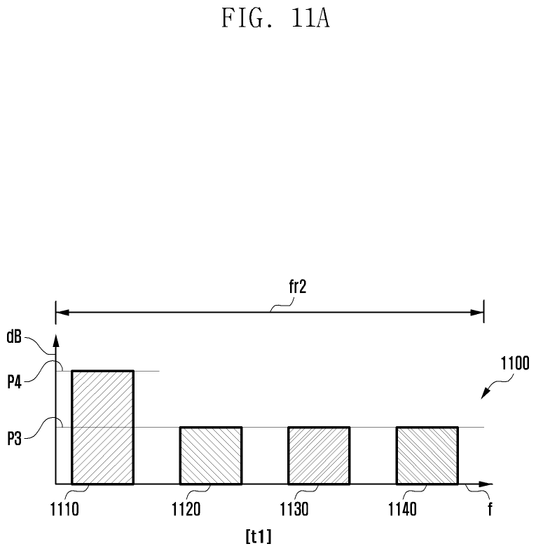

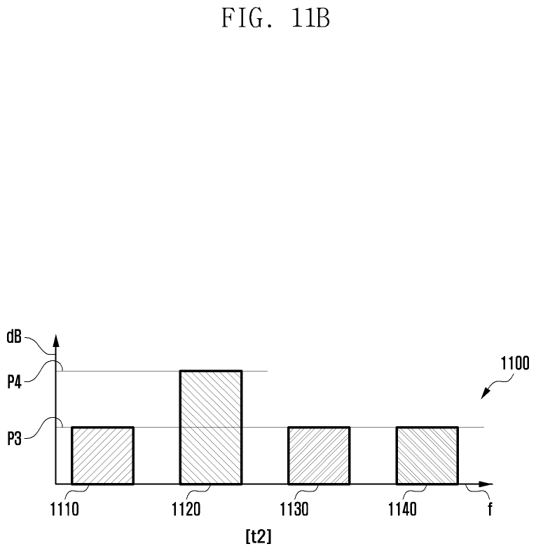

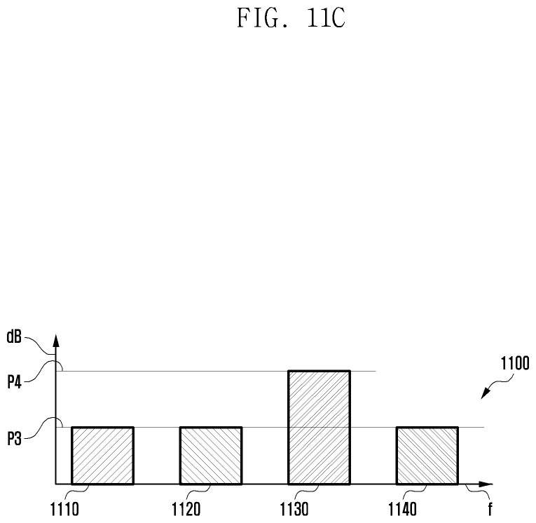

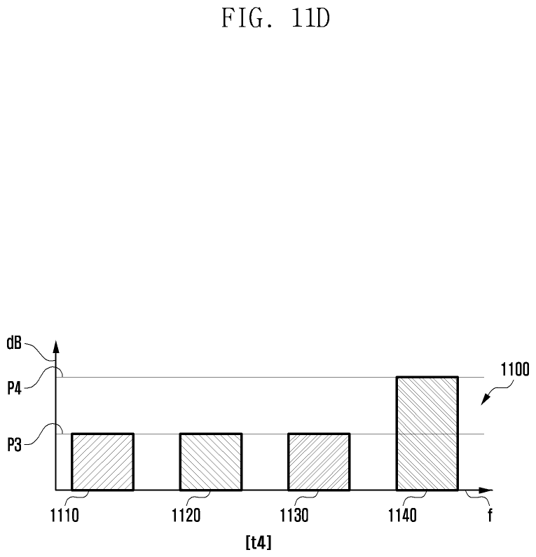

In an embodiment, the first sound S1 and the second sound S2 may correspond to different frequency ranges (e.g., audio frequency ranges). For example, the first sound S1 may correspond to a first frequency range fr1 (see FIGS. 10A to 10D). The second sound S2 may correspond to a second frequency range fr2 (see FIGS. 11A to 11D). For example, the first frequency range fr1 (see FIGS. 10A to 10D) and the second frequency range fr2 (see FIGS. 11A to 11D) may be different from each other.

In an embodiment, the electronic device 400 may simultaneously output the two sounds S1 and S2 corresponding to the different frequency ranges from the speaker unit 420, thereby removing a foreign substance which is in the passage 415 or which is disposed in proximity to the speaker unit 420. For example, the electronic device 400 may simultaneously output the first sound S1 and the second sound S2, thereby moving a foreign substance having flowed into or disposed in the passage 415, along a length of the passage 415, and through the outlet of the passage 415 to the outside of the electronic device 400. The simultaneous output of the first sound S1 and S2 may function to provide a vibration or a percussive force to move the foreign object along the passage 415, toward an outside of the electronic device 400.

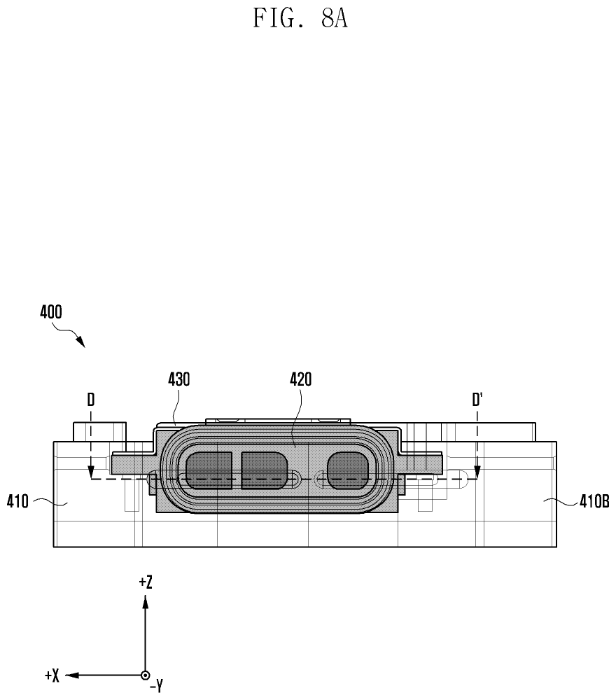

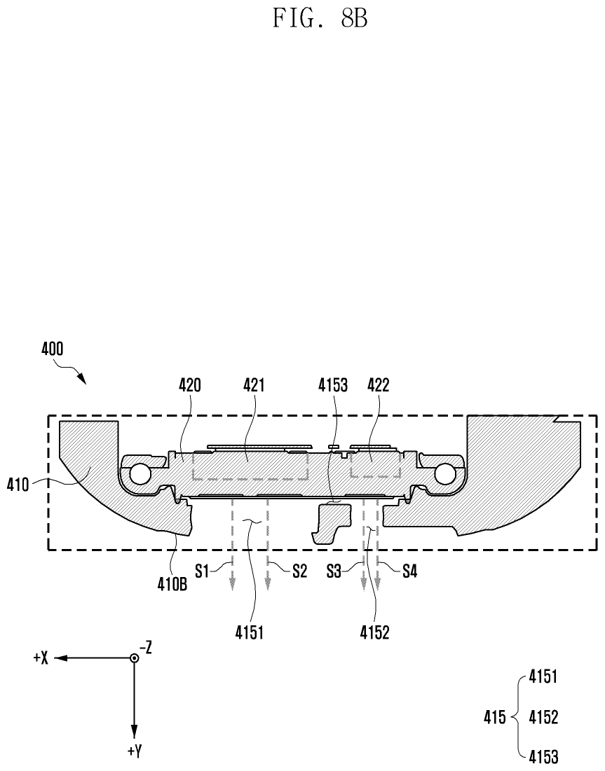

FIG. 8A and FIG. 8B illustrate an electronic device 400 according to an embodiment of the disclosure.

FIG. 8A illustrates a second surface 410B of a housing 410 according to an embodiment. FIG. 8B illustrates a cross-sectional view of the electronic device 400 along line D-D′ of FIG. 8A.

FIG. 8A may be a view showing a planar view of the second surface 410B of the housing 410 transparently. For example, FIG. 8A may be a view illustrating the housing 410 and a speaker unit 420 which is disposed in the housing 410, by showing the second surface 410B of the housing 410 transparently.

Referring to FIG. 8A, the speaker unit 420 may be disposed in the housing 410.

In an embodiment, the speaker unit 420 may include a first speaker 421 and/or a second speaker 422.

In an embodiment, the first speaker 421 may be configured to simultaneously output a first sound S1 and a second sound S2. The first sound S1 may correspond to a different frequency range from that of the second sound S2. For example, the first sound S1 may correspond to a first frequency range fr1 (see FIGS. 10A to 10D). The second sound S2 may correspond to a second frequency range fr2 (see FIGS. 11A to 11D) different from the first frequency range fr1 (see FIGS. 10A to 10D).

In an embodiment, the second speaker 422 may be configured to simultaneously output a third sound S3 and a fourth sound S4. The third sound S3 may correspond to a different frequency range from that of the fourth sound S4. For example, the third sound S3 may correspond to the first frequency range fr1 (see FIGS. 10A to 10D). The fourth sound S4 may correspond to the second frequency range fr2 (see FIGS. 11A to 11D) different from the first frequency range fr1 (see FIGS. 10A to 10D). That is, a same speaker within the speaker unit 420 may simultaneously output two different sounds in different frequency ranges from each other.

In an embodiment, the first speaker 421 and the second speaker 422 may output sounds simultaneously. In an embodiment, the second speaker 422 may also be configured to output a sound while the first speaker 421 outputs a sound. For example, the second speaker 422 may be configured to output the third sound S3 corresponding to the first frequency range fr1 (see FIGS. 10A to 10D) and/or the fourth sound S4 corresponding to the second frequency range fr2 (see FIGS. 11A to 11D) for a specified time while (e.g., at the same time) the first speaker 421 outputs the first sound S1 corresponding to the first frequency range fr1 (see FIGS. 10A to 10D) and/or the second sound S2 corresponding to the second frequency range fr2 (see FIGS. 11A to 11D).

In an embodiment, the third sound S3 may be substantially the same as the first sound S1. In an embodiment, the fourth sound S4 may be substantially the same as the second sound S2. That is, the speaker unit 420 may output more than one of the same sound, at two different locations along the speaker unit 420, e.g., from the audio output of the first speaker 421 and from the audio output of the second speaker 422.

In an embodiment, a passage 415 may be formed between the speaker unit 420 and the housing 410 and/or in at least a portion of the housing 410. For example, the passage 415 may be formed in a space or volume between the speaker unit 420 and the housing 410.

In an embodiment, a sound output from the speaker unit 420 may be transmitted to the outside of the electronic device 400, through the passage 415.

In an embodiment, the passage 415 may include a first passage 4151, a second passage 4152, and/or a common passage 4153.

In an embodiment, the first passage 4151 may be a sub-passage corresponding to the first speaker 421. For example, the first passage 4151 may be a sub-passage for transmitting a sound output from the first speaker 421 and input into first passage 4151, to the outside of the electronic device 400.

In an embodiment, the second passage 4152 may be a sub-passage corresponding to the second speaker 422. For example, the second passage 4152 may be a sub-passage for transmitting a sound output from the second speaker 422 and into the second passage 4152, to the outside of the electronic device 400.

In an embodiment, the speaker unit 420 may be configured to output a sound, based at least in part on a foreign substance being in the at least one passage 415. For example, the speaker unit 420 may be configured to output a sound, based at least in part on a foreign substance being in at least one of the first passage 4151 and the second passage 4152. Detection of the foreign substrate within the passage 415 by the electronic device 400 to affect a sound output from the speaker unit 420 is described below.

In an embodiment, the first speaker 421 may be configured to output the first sound S1 and/or the second sound S2 for a specified time, based at least in part on a foreign substance being in the first passage 4151.

In an embodiment, the second speaker 422 may be configured to output the third sound S3 and/or the fourth sound S4 for a specified time, based at least in part on a foreign substance being in the second passage 4152.

In an embodiment, the first passage 4151 and the second passage 4152 may share at least a portion. For example, in an embodiment, the first passage 4151 and/or the second passage 4152 may each include a portion of the common passage 4153. The first passage 4151 and the second passage 4152 may be in audio communication and/or fluid communication with each other via the common passage 4153.

In an embodiment, the common passage 4153 may be a sub-passage formed between the housing 410 and the speaker unit 420. For example, the common passage 4153 may be a space or volume formed between the inner surface of the housing 410 and the speaker unit 420. For example, the inner surface of the housing 410 may be a surface of the housing 410 which extends between the first and second sub-passages and faces the speaker unit 420.

In an embodiment, the common passage 4153 may correspond to each of the first speaker 421 and the second speaker 422. That is, the common passage 4153 may be audio communication and/or fluid communication with each speaker within the speaker unit 420. Sounds output from the first speaker 421 and the second speaker 422 may variously pass into, out of and through the common passage 4153.

In an embodiment, the speaker unit 420 may be configured to output a sound, based at least in part on a foreign substance being in the common passage 4153.

In an embodiment, the second speaker 422 may be configured to output the third sound S3 and/or the fourth sound S4 for a specified time, based at least in part on a foreign substance being in the common passage 4153.

In an embodiment, for example, when the electronic device 400 detects relative to a reference amount that an amount or more of a foreign substance is in the common passage 4153, the second speaker 422 may be controlled or operated to output the third sound S3 corresponding to the first frequency range fr1 (see FIGS. 10A to 10D) and/or the fourth sound S4 corresponding to the second frequency range fr2 (see FIGS. 11A to 11D) for the specified time while the first speaker 421 is controlled or operated to output the first sound S1 corresponding to the first frequency range fr1 (see FIGS. 10A to 10D) and/or the second sound S2 corresponding to the second frequency range fr2 (see FIGS. 11A to 11D).

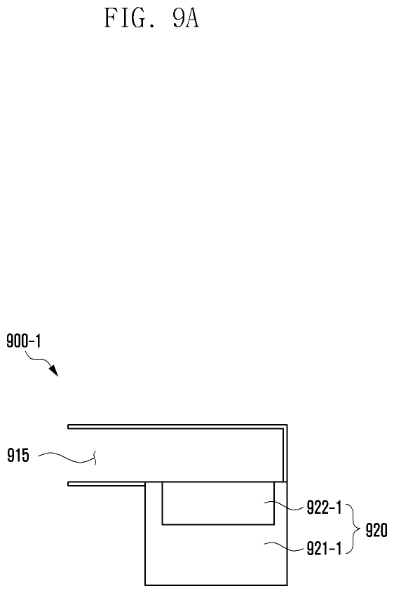

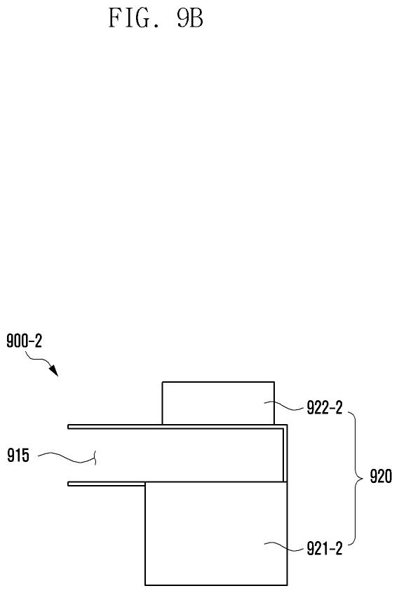

FIG. 9A and FIG. 9B illustrate electronic devices 900-1 and 900-2 according to an embodiment of the disclosure.

FIG. 9A illustrates a first speaker 921-1 including a second speaker 922-1 according to an embodiment. Here, a speaker may include a main speaker (e.g., the first speaker 921-1) and an auxiliary speaker (e.g., the second speaker 922-1. FIG. 9B illustrates a second speaker 922-2 disposed at a different position from that of a first speaker 921-2 according to an embodiment.

The electronic device 900-1 according to an embodiment may include a speaker unit 920 and/or a passage 915.

In an embodiment, the speaker unit 920 may include the first speaker 921-1 and/or the second speaker 922-1.

Referring to FIG. 9A, the first speaker 921-1 according to an embodiment may include the second speaker 922-1. Alternatively, in an embodiment, the second speaker 922-1 may be formed as a separate speaker from the first speaker 921-1 and be disposed to face the same direction as the first speaker 921-1.

In an embodiment, the first speaker 921-1 and the second speaker 922-1 may share the passage 915. For example, a sound output from the first speaker 921-1 and a sound output from the second speaker 922-1 may be transmitted through a single one of the passage 915.

Referring to FIG. 9A, in an embodiment, the first speaker 921-1 and the second speaker 922-1 may be disposed in the same direction with respect to the passage 915. That is, audio output from the speakers may travel in the same direction to be incident to the passage 915.

Referring to FIG. 9B, in an embodiment, a speaker unit 920 may include the first speaker 921-2 and/or the second speaker 922-2.

According to an embodiment, the first speaker 921-2 may be a separate speaker from the second speaker 922-2.

In an embodiment, the first speaker 921-2 may be disposed to face the second speaker 922-2, with the passage 915 therebetween. That is, audio output from the speakers may travel in different (e.g., opposing) directions to be incident to the passage 915

In an embodiment, the first speaker 921-2 and the second speaker 922-2 may share a passage 915. For example, a sound output from the first speaker 921-2 and a sound output from the second speaker 922-2 may be transmitted through a single one of the passage 915.

Referring to FIG. 9B, in an embodiment, the first speaker 921-2 and the second speaker 922-2 may be disposed in different directions with respect to the passage 915. For example, the first speaker 921-2 may be positioned in one direction with respect to the passage 915, and the second speaker 922-2 may be positioned in another direction which is opposite to the one direction with respect to the passage 915.

In an embodiment, the electronic device 900-1 and 900-2 may output a sound (e.g., the first sound 1000 of FIGS. 10A to 10D) from the speaker unit 920 to thereby generating a force to remove a foreign substance in the single one of the passage 915 which is shared by a plurality of speakers.

In an embodiment, the electronic device 900-1 and 900-2 may include a vibration actuator (not shown). In an embodiment, the vibration actuator may be configured to operate based on the output of the speaker unit 920. For example, the vibration actuator may be configured to generate vibrations while a sound (e.g., the first sound 1000 (see FIGS. 10A to 10D) or a second sound 1100 (see FIGS. 11A to 11D)) is output through the speaker unit 920. That is, the vibration actuator as a vibrator may provide a vibration force simultaneously with the speaker unit 920 outputting a particular sound.

FIGS. 10A to 10D illustrate a first sound 1000 according to an embodiment of the disclosure. The first sound 1000 as an audio signal may be defined by decibels (dB) relative to a frequency (f).

A speaker unit 420 (see FIG. 6A) according to an embodiment of the disclosure may output the first sound 1000. For example, the speaker unit 420 may be configured to perform an operation of outputting the first sound 1000 for a specified time (e.g., a time range).

In an embodiment, one speaker (e.g., a first speaker 421, see FIG. 6A) may output the first sound 1000.

In an embodiment, a plurality of speakers may simultaneously output the first sound 1000. For example, the first speaker 421 (see FIG. 6A) and a second speaker 422 (see FIG. 6A) may simultaneously output the first sound 1000.

The first sound 1000 of FIGS. 10A to 10D may refer to the first sound S1 and/or the third sound S3 of FIG. 8B, or may include the first sound S1 and/or the third sound S3 of FIG. 8B.

In an embodiment, the first sound 1000 may be a sound (e.g., audio signal) output from the speaker unit 420 (see FIG. 6A). For example, the first sound 1000 may be a set of a plurality of sounds (e.g., audio signals) output from the speaker unit 420.

Referring to FIGS. 10A to 10D, the first sound 1000 according to an embodiment may include a sub sound provided in plural including a first sub sound 1010, a second sub sound 1020, a third sub sound 1030, and/or a fourth sub sound 1040.

Although FIGS. 10A to 10D show that the first sound 1000 includes four sub sounds with different frequencies from each other, the number of sub sounds included in the first sound 1000 may not be limited thereto. For example, the first sound 1000 may include three or fewer sub sounds, or may include five or more sub sounds.

In an embodiment, the first sound 1000 may correspond to a first frequency range fr1. For example, the first sub sound 1010, the second sub sound 1020, the third sub sound 1030, and/or the fourth sub sound 1040 together forming the first sound 1000 may be sounds within the first frequency range fr1. For example, when the first frequency range fr1 is approximately 100 Hertz (Hz) to 1000 Hz, the frequency of the first sub sound 1010 may be approximately 200 Hz, the frequency of the second sub sound 1020 may be approximately 400 Hz, and the frequency of the third sub sound 1030 may be approximately 600 Hz, and the frequency of the fourth sub sound 1040 may be approximately 900 Hz.

In an embodiment, the first frequency range fr1 may be a frequency range associated with a resonance frequency of a particular speaker (e.g., the first speaker 421 of FIG. 6B). For example, in an embodiment, the resonance frequency of the particular speaker (e.g., the first speaker 421 of FIG. 6B) may be a frequency in the first frequency range fr1. Alternatively, in an embodiment, the resonance frequency of the speaker (e.g., the first speaker 421 of FIG. 6B) may be a frequency adjacent to the first frequency range fr1.

In an embodiment, the first sound 1000 may be output such that each of the sub sounds 1010, 1020, 1030, and 1040 has a predetermined sound pressure (or reference sound pressure), or greater, where the sound pressure is a deviation from the ambient (average or equilibrium) atmospheric pressure, caused by a sound wave. For example, referring to FIGS. 10A to 10D, each of the first sub sound 1010, the second sub sound 1020, the third sub sound 1030, and the fourth sub sound 1040 included in the first sound 1000 may be output with a first sound pressure P1 or greater.

In an embodiment, the first sub sound 1010, the second sub sound 1020, the third sub sound 1030, and the fourth sub sound 1040 may be sounds corresponding to different frequencies. The first sub sound 1010, the second sub sound 1020, the third sub sound 1030, and the fourth sub sound 1040 may be sounds corresponding to frequencies which are distinguished to be discontinuous from each other, that is, non-consecutive and/or non-overlapping. For example, the frequency of the first sub sound 1010 may be approximately 200 Hz, and the frequency of the second sub sound 1020 may be approximately 400 Hz. The frequency of the third sub sound 1030 may be approximately 600 Hz, and the frequency of the fourth sub sound 1040 may be approximately 900 Hz.

In an embodiment, a first period t1, a second period t2, a third period t3, and/or a fourth period t4 may refer to different durations of time.

In an embodiment, each of the first period t1, the second period t2, the third period t3, and/or the fourth period t4 may be maintained for a specified length of time.

In an embodiment, the first sound 1000 may change in sound form over time. For example, the first sound 1000 may have different sound forms in the first period t1, the second period t2, the third period t3, and the fourth period t4. The first sound 1000 may be output such that at least some sub sounds (the first sub sound 1010, the second sub sound 1020, the third sub sound 1030, or the fourth sub sound 1040) have a different sound pressure at each time (e.g., the first period t1, the second period t2, the third period t3, or the fourth period t4). A sound form of an audio sound (or audio signal) may be defined by the combination of sound pressures respectively provided by the sub sounds, within a same duration of time or time period.

In an embodiment, the first sound 1000 may change in the order of the first period t1, the second period t2, the third period t3, or the fourth period t4, over time. That is, in an embodiment, the first period t1 may be the earliest time, and the fourth period t4 may be the latest time. In this case, the first sound 1000 may have a sound form of the first period t1 (e.g., a form in which only the first sub sound 1010 is output with a second sound pressure P2) and then have a sound form of the second period t2 (e.g., a form in which only the second sub sound 1020 is output with the second sound pressure P2). The first sound 1000 may have the sound form of the second period t2 and then have a sound form of the third period t3 (e.g., a form in which only the third sub sound 1030 is output with the second sound pressure P2). The first sound 1000 may have the sound form of the third period t3 and then have a sound form of the fourth period t4 (e.g., a form in which only the fourth sub sound 1040 is output with the second sound pressure P2).

The first sound 1000 is not limited to changing in the order of the first period t1, the second period t2, the third period t3, or the fourth period t4 over time, and the order of the first period t1, the second period t2, the third period t3, or the fourth period t4 may vary. For example, in an embodiment, the first sound 1000 may change in the order of the fourth period t4, the third period t3, the second period t2, or the first period t1 over time. That is, in an embodiment, the fourth period t4 may be the earliest time, and the first period t1 may be the latest time.

In an embodiment, the first period t1, the second period t2, the third period t3, or the fourth period t4 may denote mutually discontinuous times. For example, the first sound 1000 may change to the second period t2 after a lapse of a predetermined time from the end of the first period t1. That is, adjacent time periods may be separated by a duration of time such that the adjacent time periods are non-consecutive in time.

In an embodiment, the first period t1, the second period t2, the third period t3, or the fourth period t4 may denote mutually continuous times. For example, the first sound 1000 may change to the second period t2 immediately after the first period t1. That is, adjacent time periods may not be separated by a duration of time such that a following time period is directly after a previous time period.

In an embodiment, the speaker unit 420 (see FIG. 6A) may be configured to output the first sound 1000 such that the first sound 1000 discontinuously increases or decreases within the first frequency range fr1. In an embodiment, the frequencies corresponding to the first sub sound 1010, the second sub sound 1020, the third sub sound 1030, and the fourth sub sound 1040 may be mutually discontinuous frequencies. For example, there may be a difference of a predetermined value or greater between the frequency corresponding to the first sub sound 1010 and the frequency corresponding to the second sub sound 1020. The speaker unit 420 may be configured to output the first sound 1000 such that a frequency corresponding to a predetermined sound pressure (e.g., the second sound pressure P2) discontinuously increases or decreases within the first frequency range fr1 over time.

In an embodiment, the speaker unit 420 (see FIG. 6A) may be configured to output the first sound 1000 such that the first sound 1000 continuously increases or decreases within the first frequency range fr1. In an embodiment, the frequencies corresponding to the first sub sound 1010, the second sub sound 1020, the third sub sound 1030, and the fourth sub sound 1040 may be mutually continuous frequencies. For example, there may be a difference of a predetermined value or less between the frequency corresponding to the first sub sound 1010 and the frequency corresponding to the second sub sound 1020. The speaker unit 420 may be configured to output the first sound 1000 such that the frequency corresponding to the predetermined sound pressure (e.g., the second sound pressure P2) continuously increases or decreases within the first frequency range fr1 over time.

In an embodiment, the sound pressures of the first sub sound 1010, the second sub sound 1020, the third sub sound 1030, and the fourth sub sound 1040 included in the first sound 1000 may temporarily increase in a predetermined order. For example, in each time (e.g., the first period t1, the second period t2, the third period t3, and the fourth period t4), only the sound pressure of some of a plurality of sounds included in the first sound 1000 may increase. For example, in the first period t1, only the sound pressure of the first sub sound 1010 may increase from the first sound pressure P1 to the second sound pressure P2, and in the second period t2, only the sound pressure of the second sub sound 1020 may increase from the first sound pressure P1 to the second sound pressure P2. In the third period t3, only the sound pressure of the third sub sound 1030 may increase from the first sound pressure P1 to the second sound pressure P2. In the fourth period t4, only the sound pressure of the fourth sub sound 1040 may increase from the first sound pressure P1 to the second sound pressure P2.

In an embodiment, the sound pressure of each of the first sub sound 1010, the second sub sound 1020, the third sub sound 1030, and the fourth sub sound 1040 included in the first sound 1000 may temporarily increase in a predetermined time. In an embodiment, the sound pressure of only one sound among the plurality of sounds may temporarily increase in each time (e.g., the first period t1, the second period t2, the third period t3, or the fourth period t4). For example, the sound pressure of the first sub sound 1010 may temporarily increase to the second sound pressure P2 in the first period t1, and may be maintained at the level of the first sound pressure P1 in the second period t2, the third period t3, and the fourth period t4. The sound pressure of the second sub sound 1020 may be maintained at the level of the first sound pressure P1 in the first period t1, the third period t3, and the fourth period t4, and may temporarily increase to the second sound pressure P2 in the second period t2. The sound pressure of the third sub sound 1030 may be maintained at the level of the first sound pressure P1 in the first period t1, the second period t2, and the fourth period t4, and may temporarily increase to the second sound pressure P2 in the third period t3. The sound pressure of the fourth sub sound 1040 may be maintained at the level of the first sound pressure P1 in the first period t1, the second period t2, and the third period t3, and may temporarily increase to the second sound pressure P2 in the fourth period t4.

In an embodiment, the first sound 1000 may include a plurality of sub sounds 1010, 1020, 1030, and 1040 having the different frequencies. A plurality of speakers 421 and 422 (see FIG. 6A) may be configured to output one of the plurality of sub sounds of the first sound 1000 at a sound pressure greater than that of the remaining sub sounds of the first sound 1000.

In an embodiment, the plurality of sub sounds of the first sound 1000 may include the first sub sound 1010, the second sub sound 1020, the third sub sound 1030, and the fourth sub sound 1040 having the different frequencies. The plurality of speakers 421 and 422 (see FIG. 6A) may be configured such that the first sub sound 1010, the second sub sound 1020, the third sub sound 1030, and the fourth sub sound 1040 each are alternately output with a sound pressure greater than that of the other sub sounds.

In an embodiment, the plurality of speakers 421 and 422 (see FIG. 6A) may be configured to output each of the first sub sound 1010, the second sub sound 1020, the third sub sound 1030, and the fourth sub sound 1040 at the first sound pressure P1 or greater, and to output one of the first sub sound 1010, the second sub sound 1020, the third sub sound 1030, and the fourth sub sound 1040 at the second sound pressure P2 greater than the first sound pressure P1.

In an embodiment, the speaker unit 420 (see FIG. 8B) may output the first sound 1000 to remove a foreign substance which is in a passage 415 (see FIG. 8B) or is in proximity to the speaker unit 420. The proximity of a foreign object relative to the speaker unit 420 may be defined along a length of the passage 415, without being limited thereto For example, the speaker unit 420 may output the first sound 1000 to move a foreign substance having flowed into the passage 415, to the outside of the electronic device 400.

In an embodiment, when the first sound 1000 is output simultaneously from the plurality of speakers 421 and 422 (see FIG. 6A), an effect of moving a foreign object away from one or more of the speakers and/or removing a foreign substance may be further improved than when the first sound 1000 is output from one speaker.

FIGS. 11A to 11D illustrate a second sound 1100 according to an embodiment of the disclosure. The second sound 1100 as an audio signal may be defined by decibels (dB) relative to a frequency (f).

A speaker unit 420 (see FIG. 6A) according to an embodiment of the disclosure may output the second sound 1100. For example, in an embodiment, the speaker unit 420 may be configured to perform an operation of outputting the second sound 1100 for a specified time.

In an embodiment, the speaker unit 420 (see FIG. 6A) may output the second sound 1100 to remove a foreign substance having flowed into a passage 415. For example, the speaker unit 420 may output the second sound 1100 to move water having flowed into the passage 415 to the outside of the electronic device 400.

In an embodiment, one speaker (e.g., a first speaker 421, see FIG. 6A) may output the second sound 1100.

In an embodiment, a plurality of speakers may simultaneously output the second sound 1100. For example, the first speaker 421 (see FIG. 6A) and the second speaker 422 (see FIG. 6A) may simultaneously output the second sound 1100.

The second sound 1100 of FIGS. 11A to 11D may refer to the second sound S2 and/or the fourth sound S4 of FIG. 8B, or may include the second sound S2 and/or the fourth sound S4 of FIG. 8B.

In an embodiment, the second sound 1100 may be a sound output from the speaker unit 420 (see FIG. 6A). For example, the second sound 1100 may be a set of a plurality of sounds output from the speaker unit 420.

Referring to FIGS. 11A to 11D, the second sound 1100 according to an embodiment may include a fifth sub sound 1110, a sixth sub sound 1120, a seventh sub sound 1130, and/or an eighth sub sound 1140.

Although FIGS. 11A to 11D show that the second sound 1100 includes four sub sounds with different frequencies, the number of sub sounds included in the second sound 1100 may not be limited thereto. For example, the second sound 1100 may include three or fewer sub sounds, or may include five or more sub sounds.

In an embodiment, the second sound 1100 may correspond to a second frequency range fr2. For example, the fifth sub sound 1110, the sixth sub sound 1120, the seventh sub sound 1130, and the eighth sub sound 1140 forming the second sound 1100 may be sounds within the second frequency range fr2. For example, when the second frequency range fr2 is approximately 0.5 kilohertz (kHz) to 5 kHz, the frequency of the fifth sub sound 1110 may be approximately 1 kHz, the frequency of the sixth sub sound 1120 may be approximately 2 kHz, the frequency of the seventh sub sound 1130 may be approximately 3 kHz, and the frequency of the eighth sub sound 1140 may be approximately 4 kHz.

In an embodiment, the second frequency range fr2 may be at least partly different from the first frequency range fr1 of FIGS. 10A to 10D.

In an embodiment, the second frequency range fr2 may be a frequency range associated with a resonance frequency of a particular speaker (e.g., the second speaker 422 of FIG. 6B). For example, in an embodiment, the resonance frequency of the particular speaker (e.g., the second speaker 422 of FIG. 6B) may be a frequency in the second frequency range fr2. Alternatively, in an embodiment, the resonance frequency of the particular speaker (e.g., the second speaker 422 of FIG. 6B) may be a frequency adjacent to the second frequency range fr2.

In an embodiment, the first frequency range fr1 (see FIGS. 10A to 10D) and the second frequency range fr2 may be continuous. For example, the first frequency range fr1 (see FIGS. 10A to 10D) may include at least a portion of the second frequency range fr2, or may be a frequency range connected to the second frequency range fr2. Alternatively, in an embodiment, the difference between a frequency corresponding to the first frequency range fr1 (see FIGS. 10A to 10D) and a frequency corresponding to the second frequency range fr2 may be a predetermined value or less.

In an embodiment, the second sound 1100 may be output such that each of the sub sounds 1110, 1120, 1130, and 1140 has a predetermined sound pressure or greater. For example, referring to FIGS. 11A to 11D, each of the fifth sub sound 1110, the sixth sub sound 1120, and the seventh sub sound 1130, and the eighth sub sound 1140 included in the second sound 1100 may be output with a third sound pressure P3 or greater.

In an embodiment, the fifth sub sound 1110, the sixth sub sound 1120, the seventh sub sound 1130, and the eighth sub sound 1140 may be sounds corresponding to different frequencies. The fifth sub sound 1110, the sixth sub sound 1120, the seventh sub sound 1130, and the eighth sub sound 1140 may be sounds corresponding to frequencies which are distinguished to be discontinuous from each other. For example, the frequency of the fifth sub sound 1110 may be approximately 1 kHz, and the frequency of the sixth sub sound 1120 may be approximately 2 kHz. The frequency of the seventh sub sound 1130 may be approximately 3 kHz, and the frequency of the eighth sub sound 1140 may be approximately 4 kHz.

In an embodiment, a first period t1, a second period t2, a third period t3, and a fourth period t4 may refer to different times (e.g., different durations of time).

In an embodiment, each of the first period t1, the second period t2, the third period t3, and the fourth period t4 may be maintained for a specified length of time.

In an embodiment, the second sound 1100 may change in sound form over time. For example, the second sound 1100 may have different sound forms in the first period t1, the second period t2, the third period t3, and the fourth period t4. The second sound 1100 may be output such that at least some sub sounds (the fifth sub sound 1110, the sixth sub sound 1120, the seventh sub sound 1130, or the eighth sub sound 1140) have a different sound pressure at each time (e.g., the first period t1, the second period t2, the third period t3, or the fourth period t4).

In an embodiment, the second sound 1100 may change in the order of the first period t1, the second period t2, the third period t3, or the fourth period t4 over time. That is, in an embodiment, the first period t1 may be the earliest time, and the fourth period t4 may be the latest time. In this case, the second sound 1100 may have a sound form of the first period t1 (e.g., a form in which only the fifth sub sound 1110 is output with a fourth sound pressure P4) and then have a sound form of the second period t2 (e.g., a form in which only the sixth sub sound 1120 is output with the fourth sound pressure P4). The second sound 1100 may have the sound form of the second period t2 and then have a sound form of the third period t3 (e.g., a form in which only the seventh sub sound 1130 is output with the fourth sound pressure P4). The second sound 1100 may have the sound form of the third period t3 and then have a sound form of the fourth period t4 (e.g., a form in which only the eighth sub sound 1140 is output with the fourth sound pressure P4).

The second sound 1100 is not limited to changing in the order of the first period t1, the second period t2, the third period t3, or the fourth period t4 over time, and the order of the first period t1, the second period t2, the third period t3, or the fourth period t4 may vary. For example, the second sound 1100 may change in the order of the fourth period t4, the third period t3, the second period t2, or the first period t1 over time. That is, in an embodiment, the fourth period t4 may be the earliest time, and the first period t1 may be the latest time.

In an embodiment, the first period t1, the second period t2, the third period t3, or the fourth period t4 may denote mutually discontinuous times. For example, the second sound 1100 may change to the second period t2 after a lapse of a predetermined time from the end of the first period t1.

In an embodiment, the first period t1, the second period t2, the third period t3, or the fourth period t4 may denote mutually continuous times. For example, the second sound 1100 may change to the second period t2 immediately after the first period t1.

In an embodiment, the speaker unit 420 (see FIG. 6A) may be configured to output the second sound 1100 such that the second sound 1100 discontinuously increases or decreases within the second frequency range fr2. In an embodiment, the frequencies corresponding to the fifth sub sound 1110, the sixth sub sound 1120, the seventh sub sound 1130, and the eighth sub sound 1140 may be mutually discontinuous frequencies. For example, there may be a difference of a predetermined value or greater between the frequency corresponding to the fifth sub sound 1110 and the frequency corresponding to the sixth sub sound 1120. The speaker unit 420 may be configured to output the second sound 1100 such that the frequency corresponding to a predetermined sound pressure (e.g., the fourth sound pressure P4) discontinuously increases or decreases within the second frequency range fr2 over time.

In an embodiment, the speaker unit 420 (see FIG. 6A) may be configured to output the second sound 1100 such that the second sound 1100 continuously increases or decreases within the second frequency range fr2. In an embodiment, the frequencies corresponding to the fifth sub sound 1110, the sixth sub sound 1120, the seventh sub sound 1130, and the eighth sub sound 1140 may be mutually continuous frequencies. For example, there may be a difference of a predetermined value or less between the frequency corresponding to the fifth sub sound 1110 and the frequency corresponding to the sixth sub sound 1120. The speaker unit 420 may be configured to output the second sound 1100 such that the frequency corresponding to a predetermined sound pressure (e.g., the fourth sound pressure P4) continuously increases or decreases within the second frequency range fr2 over time.

In an embodiment, the sound pressures of the fifth sub sound 1110, the sixth sub sound 1120, the seventh sub sound 1130, and the eighth sub sound 1140 included in the second sound 1100 may temporarily increase in a predetermined order. For example, in each time (e.g., the first period t1, the second period t2, the third period t3, and the fourth period t4), only the sound pressure of some of a plurality of sounds included in the second sound 1100 may increase. For example, in the first period t1, only the sound pressure of the fifth sub sound 1110 may increase from the third sound pressure P3 to the fourth sound pressure P4, and in the second period t2, only the sound pressure of the sixth sub sound 1120 may increase from the third sound pressure P3 to the fourth sound pressure P4. In the third period t3, only the sound pressure of the seventh sub sound 1130 may increase from the third sound pressure P3 to the fourth sound pressure P4. In the fourth period t4, only the sound pressure of the eighth sub sound 1140 may increase from the third sound pressure P3 to the fourth sound pressure P4.

In an embodiment, the sound pressure of each of the fifth sub sound 1110, the sixth sub sound 1120, the seventh sub sound 1130, and the eighth sub sound 1140 included in the second sound 1100 may temporarily increase in a predetermined time. In an embodiment, the sound pressure of only one sound may temporarily increase in each time (e.g., the first period t1, the second period t2, the third period t3, or the fourth period t4). For example, the sound pressure of the fifth sub sound 1110 may temporarily increase to the fourth sound pressure P4 in the first period t1, and may be maintained at the level of the third sound pressure P3 in the second period t2, the third period t3, and the fourth period t4. The sound pressure of the sixth sub sound 1120 may be maintained at the level of the third sound pressure P3 in the first period t1, the third period t3, and the fourth period t4, and may temporarily increase to the fourth sound pressure P4 in the second period t2. The sound pressure of the seventh sub sound 1130 may be maintained at the level of the third sound pressure P3 in the first period t1, the second period t2, and the fourth period t4, and may temporarily increase to the fourth sound pressure P4 in the third period t3. The sound pressure of the eighth sub sound 1140 may be maintained at the level of the third sound pressure P3 in the first period t1, the second period t2, and the third period t3, and may temporarily increase to the fourth sound pressure P4 in the fourth period t4.

In an embodiment, the second sound 1100 may include a plurality of sub sounds 1110, 1120, 1130, and 1140 having the different frequencies. A plurality of speakers 421 and 422 (see FIG. 6A) may be configured to output one of the plurality of sub sounds of the second sound 1100 with a sound pressure greater than that of the remaining sub sounds of the second sound 1100.

In an embodiment, the plurality of sub sounds of the second sound 1100 may include the fifth sub sound 1110, the sixth sub sound 1120, the seventh sub sound 1130, and the eighth sub sound 1140 having the different frequencies. The plurality of speakers 421 and 422 (see FIG. 6A) may be configured such that the fifth sub sound 1110, the sixth sub sound 1120, the seventh sub sound 1130, and the eighth sub sound 1140 each are alternately output with a sound pressure greater than that of the other sub sounds.

In an embodiment, the plurality of speakers 421 and 422 (see FIG. 6A) may be configured to output the fifth sub sound 1110, the sixth sub sound 1120, the seventh sub sound 1130, and the eighth sub sound 1140 with the third sound pressure P3 or greater, and to output one of the fifth sub sound 1110, the sixth sub sound 1120, the seventh sub sound 1130, and the eighth sub sound 1140 with the fourth sound pressure P4 greater than the third sound pressure P3.

In an embodiment, the second sound 1100 may be output with the same phase as the first sound 1000 of FIGS. 10A to 10D. For example, the first period t1, the second period t2, the third period t3, and the fourth period t4 in which the second sound 1100 is output may be substantially the same as the first period t1, the second period t2, the third period t3, and the fourth period t4 in which the first sound 1000 is output in FIGS. 10A to 10D, respectively.

In an embodiment, one speaker (e.g., the first speaker 421, see FIG. 6A) may output the first sound 1000 and the second sound 1100 in the same phase.

In an embodiment, the plurality of speakers may output the plurality of sounds in the same phase. For example, the first speaker 421 (see FIG. 6A) and the second speaker 422 (see FIG. 6A) may output the first sound 1000 (see FIGS. 10A to 10D) and the second sound 1100 in the same phase.

In an embodiment, the speaker unit 420 (see FIG. 8B) may output the first sound 1000 (see FIGS. 10A to 10D) or the second sound 1100 to remove a foreign substance in a passage 415 (see FIG. 8B) or in proximity to the speaker unit 420. For example, the speaker unit 420 may output the first sound 1000 and the second sound 1100 to move a foreign substance having flowed into the passage 415, to the outside of the electronic device 400.

In an embodiment, the first sound pressure P1 and the third sound pressure P3 may be a minimum sound pressure within the first sound 1000 and the second sound 1100 respectively without being limited thereto.

In an embodiment, when the plurality of speakers outputs the plurality of sounds in the same phase, an effect of removing a foreign substance may be further improved than when the plurality of speakers outputs only one sound.

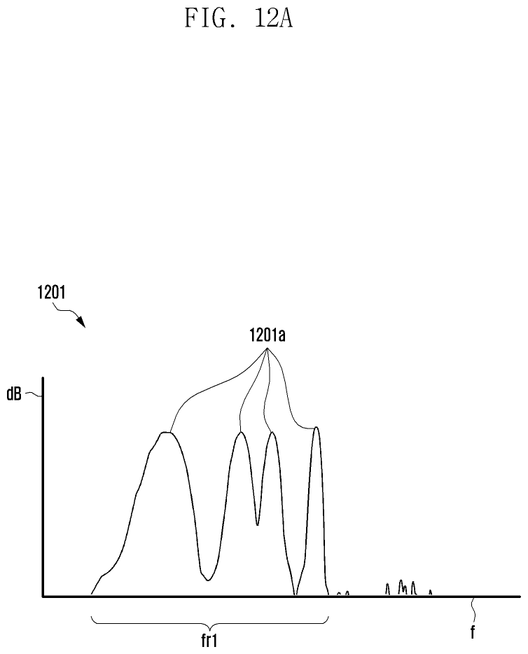

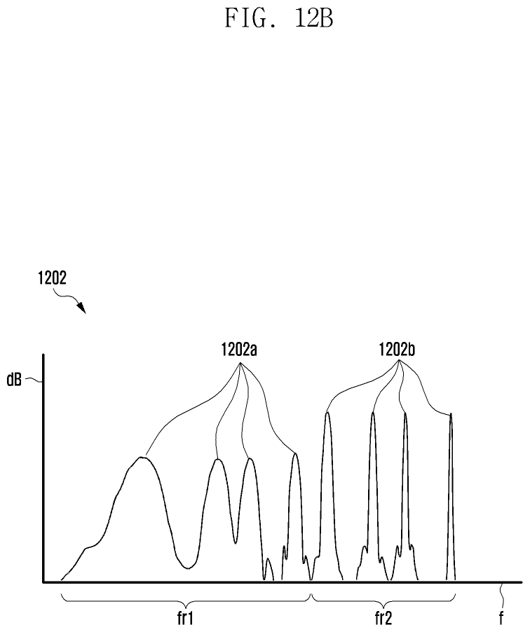

FIG. 12A and FIG. 12B illustrate sound pressure graphs 1201 and 1202 according to an embodiment of the disclosure.

FIG. 12A is a first graph 1201 illustrating a sound pressure according to a frequency when a first sound 1201a is output. FIG. 12B is a second graph 1202 illustrating a sound pressure according to a frequency when a first sound 1202a and a second sound 1202b are output simultaneously.

In the first graph 1201 of FIG. 12A and the second graph 1202 of FIG. 12B, a horizontal axis may denote the frequency (f) of a sound, and a vertical axis may denote the sound pressure level of a sound in decibels (dB).

Referring to the first graph 1201 of FIG. 12A, the first sound 1201a may be output from a speaker unit (e.g., the speaker unit 420 of FIG. 6A). The first sound 1201a may refer to the first sound 1000 of FIGS. 10A to 10D, or may include at least part of the first sound 1000 of FIGS. 10A to 10D.

In an embodiment, the first sound 1201a may correspond to a first frequency range fr1. For example, referring to the first graph 1201 of FIG. 12A, the first sound 1201a may have a frequency in the first frequency range fr1.

In an embodiment, the first sound 1201a may have a sound pressure which varies within a predetermined frequency range. For example, in an embodiment, the first sound 1201a may be output to have a plurality of local peaks within the first frequency range fr1 (e.g., four peaks indicated in FIG. 12A, for example). Referring to the first graph 1201 of FIG. 12A, the first sound 1201a may form the plurality of local peaks of the sound pressure at different frequencies f in the first frequency range fr1.

In an embodiment, when the first sound 1201a corresponding to the first frequency range fr1 is output from the speaker unit (e.g., the speaker unit 420 of FIG. 6A), a foreign substance having flowed into a passage 415 (see FIG. 8B) of an electronic device 400 (see FIG. 8B) may be moved within or removed from the passage 415.

Referring to the second graph 1202 of FIG. 12B, the first sound 1202a and the second sound 1202b may be simultaneously output from the speaker unit (e.g., the speaker unit 420 of FIG. 6A). The first sound 1202a may refer to the first sound 1000 of FIGS. 10A to 10D, or may include at least part of the first sound 1000 of FIGS. 10A to 10D. The second sound 1202b may refer to the second sound 1100 of FIGS. 11A to 11D, or may include at least part of the second sound 1100 of FIGS. 11A to 11D.

In an embodiment, the first sound 1202a may correspond to a first frequency range fr1. For example, referring to the second graph 1202 of FIG. 12B, the first sound 1202a may have a frequency in the first frequency range fr1.

In an embodiment, the second sound 1202b may correspond to a second frequency range fr2. For example, referring to the second graph 1202 of FIG. 12B, the second sound 1202b may have a frequency in the second frequency range fr2.

In an embodiment, when the first sound 1202a corresponding to the first frequency range fr1 and the second sound 1202b corresponding to the second frequency range fr2 are simultaneously output from the speaker unit (e.g., the speaker unit 420 of FIG. 6A), a foreign substance having flowed into a passage 415 (see FIG. 8B) of an electronic device 400 (see FIG. 8B) may be moved within or removed from the passage 415. Here, the first sound 1202a and the second sound 1202b are simultaneously output to have a plurality of local peaks within the first frequency range fr1 together with the second frequency range fr2 (e.g., eight peaks indicated in FIG. 12B, for example). Referring to the second graph 1202 of FIG. 12B, the first sound 1201a and the second sound 1202b may form a larger number of local peaks at different frequencies f.

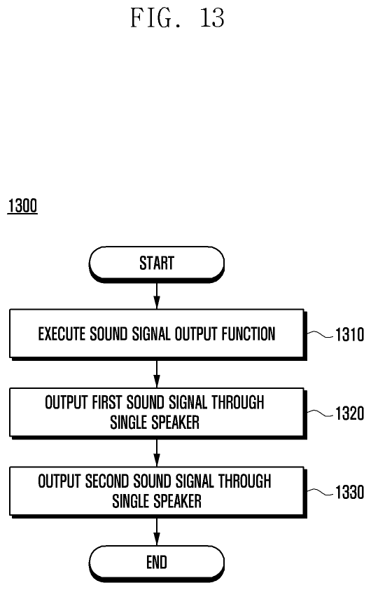

FIG. 13 illustrates a sound signal output method 1300 according to an embodiment of the disclosure.

In an embodiment, the sound signal output method 1300 may be performed, for example, according to a flowchart illustrated in FIG. 13. Since the flowchart illustrated in FIG. 13 is merely a flowchart of the sound signal output method 1300 according to an embodiment, the order of operations may be changed, or operations may be performed simultaneously.

In an embodiment, each operation of the sound signal output method 1300 may be performed under control of a processor (e.g., the processor 120 of FIG. 1) of an electronic device 400.

In an embodiment, the sound signal output method 1300 may include a sound signal output function execution operation 1310, a first sound signal output operation through a single speaker 1320, and/or a second sound signal output operation through a single speaker 1330.

In an embodiment, in the sound signal output function execution operation 1310, the electronic device 400 may be configured to execute a function of outputting a sound through a speaker (e.g., a first speaker 421) to remove a foreign substance having flowed into a passage 415.

In an embodiment, removing the foreign substance having flowed into the passage 415 may include moving the foreign substance having flowed in to the outside of the electronic device 400 through the sound and/or drying the foreign substance (e.g., water) having flowed in by heat generation.

In an embodiment, the electronic device 400 may be configured to perform the sound signal output function execution operation 1310, based on an event occurring. For example, the electronic device 400 may be configured to automatically perform the sound signal output function execution operation 1310 when a predetermined mode (e.g., a waterproof mode) is configured and then released. In an embodiment, the electronic device 400 may be configured to detect that a foreign substance flows into the passage 415 through a detection sensor, and perform the sound signal output function execution operation 1310. In an embodiment, the electronic device 400 may be configured to recognize a surrounding environment of the electronic device 400, and perform the sound signal output function execution operation 1310. In an embodiment, the electronic device 400 may be configured to recognize the state of the speaker (e.g., the first speaker 421), and perform the sound signal output function execution operation 1310. In an embodiment, the electronic device 400 may be configured to perform the sound signal output function execution operation 1310, based at least in part on a specified user input.

In an embodiment, when the sound signal output function execution operation 1310 is performed, the electronic device 400 may perform the first sound signal output operation through the single speaker 1320.

In an embodiment, the electronic device 400 may output a first sound signal through a single speaker (e.g., the first speaker 421) for a specified time in the first sound signal output operation through the single speaker 1320. In an embodiment, the first sound signal may include at least one sound. For example, the first sound signal may include a first sound 1000 and/or a second sound 1100.

In an embodiment, the first sound signal may be a signal for removing a foreign substance flowing into the passage 415. For example, the speaker (e.g., the first speaker 421) may push a foreign substance having flowed into the passage 415 out of the electronic device 400 through the first sound signal.

In an embodiment, after performing the first sound signal output operation through the single speaker 1320, the electronic device 400 may perform the second sound signal output operation through the single speaker 1330.

In an embodiment, the electronic device 400 may output a second sound signal through the single speaker (e.g., the first speaker 421) for a specified time in the second sound signal output operation through the single speaker 1330. The second sound signal may be a different signal from the first sound signal (e.g., the first sound 1000 or the second sound 1100). For example, the first sound signal may be a sound in an audible frequency range which a human being is able to hear, and the second sound signal may be a sound in an inaudible frequency range (e.g., 19 to 20 kHz and 20 to 50 kHz) which a human being is unable to hear.

In an embodiment, the second sound signal may be a signal for removing the foreign substance remaining in the passage 415 through heat. For example, the speaker (e.g., a first speaker 421) may output the second sound signal to generate heat. The foreign substance (e.g., water) remaining in the passage 415 after the first sound signal is output may be removed (e.g., evaporated) by the heat generated through the second sound signal.

In an embodiment, the second sound signal output in the second sound signal output operation through the single speaker 1330 may be output for a longer time than the first sound signal (e.g., the first sound 1000 or the second sound 1100).

In an embodiment, since the second sound signal is the sound in the inaudible frequency range which a user is unable to hear, the second sound signal may not interfere with the user using the electronic device 400 even though output for a longer time than the first sound signal.

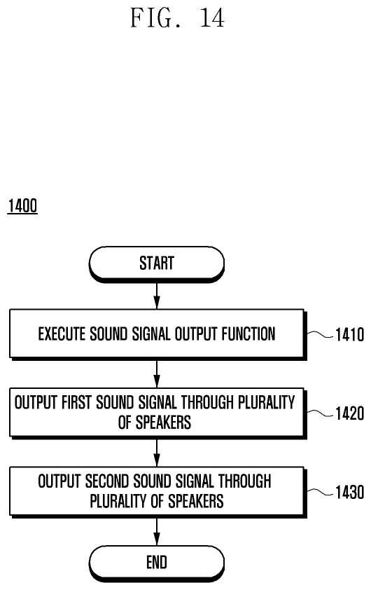

FIG. 14 illustrates a sound signal output method 1400 according to an embodiment of the disclosure.

In an embodiment, the sound signal output method 1400 may be performed, for example, according to a flowchart illustrated in FIG. 14. Since the flowchart illustrated in FIG. 14 is merely a flowchart of the sound signal output method 1400 according to an embodiment, the order of operations may be changed, or operations may be performed simultaneously.

In an embodiment, each operation of the sound signal output method 1400 may be performed under control of a processor (e.g., the processor 120 of FIG. 1) of an electronic device 400.

In an embodiment, the sound signal output method 1400 may include a sound signal output function execution operation 1410, a first sound signal output operation through a plurality of speakers 1420, and/or a second sound signal output operation through a plurality of speaker 1430.

The sound signal output function execution operation 1410 of FIG. 14 may be substantially the same as the sound signal output function execution operation 1310 of FIG. 13. In describing the operations of the sound signal output method 1400 of FIG. 14, a description of an operation substantially the same as that of the sound signal output method 1300 of FIG. 13 may be omitted.

In an embodiment, when the sound signal output function execution operation 1410 is performed, the electronic device 400 may perform the first sound signal output operation through the plurality of speakers 1420.

In an embodiment, the electronic device 400 may output a first sound signal through a plurality of speakers (e.g., a first speaker 421 and a second speaker 422) for a specified time in the first sound signal output operation through the plurality of speaker 1420. In an embodiment, the first sound signal may include at least one sound. For example, the first sound signal may include a first sound 1000 and/or a second sound 1100.

In an embodiment, in the first sound signal output operation through the plurality of speakers 1420, the number of sounds output from the plurality of speakers (e.g., the first speaker 421 and the second speaker 422) may vary based on characteristics of the plurality of speakers. For example, the number of sounds output from the plurality of speakers may be substantially the same as the number of speakers having substantially different characteristics. In an embodiment, when N speakers have different characteristics (e.g., resonance frequencies of the speakers), N sounds may be output simultaneously from the N speakers. For example, when there are two speakers and the two speakers have different characteristics, two sounds (e.g., the first sound 1000 or the second sound 1100) may be output simultaneously from the two speakers (e.g., the first speaker 421 or the second speaker 422). In an embodiment, when two speakers among the N speakers are substantially the same speakers, N−1 sounds may be output simultaneously from the N speakers. For example, when there are three speakers and two are substantially the same speakers, two sounds may be output simultaneously from the three speakers.

In an embodiment, after performing the first sound signal output operation through the plurality of speakers 1420, the electronic device 400 may perform the second sound signal output operation through the plurality of speakers 1430.

In an embodiment, the electronic device 400 may output a second sound signal through the plurality of speakers (e.g., the first speaker 421 and the second speaker 422) for a specified time in the second sound signal output operation through the plurality of speakers 1430. The second sound signal may be a different signal from the first sound signal (e.g., the first sound 1000 or the second sound 1100). For example, the first sound signal may be a sound in an audible frequency range which a human being is able to hear, and the second sound signal may be a sound in an inaudible frequency range which a human being is unable to hear.

In an embodiment, the electronic device 400 may alleviate a restriction on heat generation of the speaker unit 420 in the first sound signal output operations 1320 and 1420 and the second sound signal output operation 1330 and 1430. For example, when the first sound signal output operations 1320 and 1420 and the second sound signal output operation 1330 and 1430 are performed, the electronic device 400 may increase the maximum temperature which a coil of the speaker unit 420 is able to reach. For example, when the first sound signal output operations 1320 and 1420 and the second sound signal output operation 1330 and 1430 are performed, the electronic device 400 may increase the maximum temperature which the coil of the speaker unit 420 is able to reach from about 110 degrees to about 120 degrees.

In an embodiment, when the electronic device 400 performs both the first sound signal output operations 1320 and 1420 and the second sound signal output operations 1330 and 1430 through the plurality of speakers, an effect of removing a foreign substance having flowed into a passage 415 may be further improved than when outputting only the first sound signal 1320 and 1420 through the single speaker or the plurality of speakers.

In an embodiment, when the electronic device 400 outputs a sound through a plurality of speakers, an effect of removing a foreign substance having flowed into the passage 415 may further improved than when outputting a sound through only one speaker. For example, when the electronic device 400 outputs a sound through a plurality of speakers according to the sound signal output method 1400 of FIG. 14, an effect of removing a foreign substance having flowed into the passage 415 may be further improved than when outputting a sound through a single speaker according to the sound signal output method 1300 of FIG. 13.

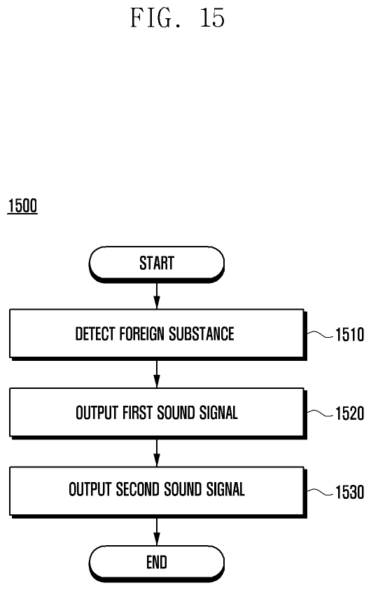

FIG. 15 illustrates a foreign substance detection-based sound signal output method 1500.

In an embodiment, the foreign substance detection-based sound signal output method 1500 may be performed, for example, according to a flowchart illustrated in FIG. 15. Since the flowchart illustrated in FIG. 15 is merely a flowchart of the foreign substance detection-based sound signal output method 1500 according to an embodiment, the order of operations may be changed, or operations may be performed simultaneously.

In an embodiment, each operation of the foreign substance detection-based sound signal output method 1500 may be performed under control of a processor (e.g., the processor 120 of FIG. 1) of an electronic device 400.

In an embodiment, the foreign substance detection-based sound signal output method 1500 may include a foreign substance detection operation 1510, a first sound signal output operation 1520, and/or a second sound signal output operation 1530.

In an embodiment, the electronic device 400 may detect, using a sensor, that a foreign substance which is in a passage 415 or in proximity to a speaker unit 420 of the electronic device 400 in the foreign substance detection operation 1510.

In an embodiment, the electronic device 400 may perform the first sound signal output operation 1520, based at least in part on the foreign substance detection operation 1510. For example, when the sensor of the electronic device 400 detects that the foreign substance which is in the passage 415 or in proximity to the speaker unit 420 in the foreign substance detection operation 1510, the electronic device 400 may perform the first sound signal output operation 1520.

In an embodiment, the electronic device 400 may perform the first sound signal output operation 1520, based at least in part on the amount of the foreign substance detected in the foreign substance detection operation 1510. For example, when determining that the amount of the foreign substance which is in the passage 415 or in proximity to the speaker unit 420 is greater than a predetermined amount in the foreign substance detection operation 1510, the electronic device 400 may perform the first sound signal output operation 1520. In an embodiment, the electronic device 400 may include a measurement sensor configured to measure the amount of a foreign substance which is in the passage 415 or in proximity to the speaker unit 420.

In an embodiment, the electronic device 400 may output a first sound signal through the speaker unit 420 for a specified time in the first sound signal output operation 1520. In an embodiment, the first sound signal may include at least one sound. For example, the first sound signal may include a first sound 1000 and/or a second sound 1100.

In an embodiment, the speaker unit 420 may be configured to output a sound such that a frequency range or a sound level is adjusted based at least in part on the amount of the foreign substance detected in the foreign substance detection operation 1510 in the first sound signal output operation 1520. For example, the speaker unit 420 may be configured to output the first sound 1000 and/or the second sound 1100 such that at least one of a first frequency range fr1 or a second frequency range fr2 is adjusted based at least in part on the amount of the foreign substance detected in the foreign substance detection operation 1510 in the first sound signal output operation 1520. Alternatively, the speaker unit 420 may be configured to output the first sound 1000 and/or the second sound 1100 such that the level of at least one of the first sound 1000 and/or the second sound 1100 is adjusted based at least in part on the amount of the foreign substance detected in the foreign substance detection operation 1510 in the first sound signal output operation 1520.

In an embodiment, the speaker unit 420 may be configured to increase or decrease the specified time for which the first sound signal (e.g., the first sound 1000 and/or the second sound 1100) is output, based at least in part on the amount of the foreign substance detected in the foreign substance detection operation 1510 in the first sound signal output operation 1520.

In an embodiment, after performing the first sound signal output operation 1520, the electronic device 400 may perform the second sound signal output operation 1530.

In an embodiment, the electronic device 400 may output a second sound signal through the speaker unit 420 for a specified time in the second sound signal output operation 1530. The second sound signal may be a different signal from the first sound signal (e.g., the first sound 1000 or the second sound 1100). For example, the first sound signal may be a sound in an audible frequency range which a human being is able to hear, and the second sound signal may be a sound in an inaudible frequency range which a human being is unable to hear.

In an embodiment, the second sound signal output in the second sound signal output operation 1530 may be output for a longer time than the first sound signal output in the first sound signal output operation 1520 (e.g., the first sound 1000 or the second sound 1100).

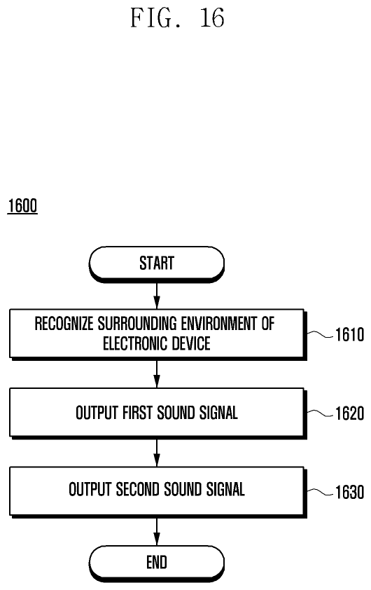

FIG. 16 illustrates a surrounding environment-based sound signal output method 1600.

In an embodiment, the surrounding environment-based sound signal output method 1600 may be performed, for example, according to a flowchart illustrated in FIG. 16. Since the flowchart illustrated in FIG. 16 is merely a flowchart of the surrounding environment-based sound signal output method 1600 according to an embodiment, the order of operations may be changed, or operations may be performed simultaneously.

In an embodiment, each operation of the surrounding environment-based sound signal output method 1600 may be performed under control of a processor (e.g., the processor 120 of FIG. 1) of an electronic device 400.

In an embodiment, the surrounding environment-based sound signal output method 1600 may include an operation 1610 of recognizing a surrounding environment of an electronic device, a first sound signal output operation 1620, and/or a second sound signal output operation 1630.

In an embodiment, the electronic device 400 may recognize a surrounding environment of the electronic device 400 in the operation 1610 of recognizing the surrounding environment of the electronic device. The surrounding environment of the electronic device 400 may include the ambient noise level of the electronic device 400 or the current position of the electronic device 400. In an embodiment, in the operation 1610, the electronic device 400 may recognize the ambient noise level of the electronic device 400 (e.g., the ambient sound pressure level of the electronic device 400). In an embodiment, in the operation 1610, the electronic device 400 may recognize the current position of the electronic device 400. For example, the electronic device 400 may recognize whether the electronic device 400 is in a place where an ambient sound is relatively small (e.g., a library) or a place where an ambient sound is relatively big (e.g., a stadium or a concert hall).

In an embodiment, the electronic device 400 may perform the operation 1610 of recognizing the surrounding environment of the electronic device after performing the sound signal output function execution operation 1310 of FIG. 13, the sound signal output function execution operation 1410 of FIG. 14, or the foreign substance detection operation 1510 of FIG. 15. For example, in an embodiment, after being configured to perform a function of outputting an sound signal to remove a foreign substance having flowed into a passage 415 through the sound signal output function execution operations 1310 and 1410, the electronic device 400 may perform the operation 1610 of recognizing the surrounding environment of the electronic device 400 to recognize the surrounding environment of the electronic device 400. Alternatively, in an embodiment, the electronic device 400 may detect, using a sensor, that a foreign substance is in proximity to the passage 415 or a speaker unit 420 through the foreign substance detection operation 1510, and then perform the operation 1610 of recognizing the surrounding environment of the electronic device 400 to recognize the surrounding environment of the electronic device 400.

In an embodiment, the electronic device 400 may output a first sound signal through the speaker unit 420 for a specified time in the first sound signal output operation 1620. In an embodiment, the first sound signal may include at least one sound. For example, the first sound signal may include a first sound 1000 and/or a second sound 1100.

In an embodiment, the electronic device 400 may perform the first sound signal output operation 1620, based at least in part on the operation 1610 of recognizing the surrounding environment of the electronic device.

In an embodiment, the speaker unit 420 of the electronic device 400 may be configured to output a sound such that a frequency range or a sound level is adjusted based at least in part on the surrounding environment of the electronic device 400 recognized in the operation 1610 of recognizing the surrounding environment of the electronic device in the first sound signal output operation 1620. For example, the speaker unit 420 may be configured to output the first sound 1000 and/or the second sound 1100 such that at least one of a first frequency range fr1 or a second frequency range fr2 is adjusted based at least in part on a surrounding environment element (e.g., external noise) of the electronic device 400 recognized in the operation 1610 of recognizing the surrounding environment of the electronic device in the first sound signal output operation 1620. Alternatively, the speaker unit 420 may be configured to output the first sound 1000 and/or the second sound 1100 such that the level of at least one of the first sound 1000 and/or the second sound 1100 is adjusted based at least in part on the surrounding environment element (e.g., the external noise) of the electronic device 400 recognized in the operation 1610 of recognizing the surrounding environment of the electronic device in the first sound signal output operation 1620.

In an embodiment, the speaker unit 420 may be configured to increase or decrease the specified time for which the first sound signal (e.g., the first sound 1000 and/or the second sound 1100) is output, based at least in part on the surrounding environment element (e.g., the external noise) of the electronic device 400 recognized in the operation 1610 of recognizing the surrounding environment of the electronic device in the first sound signal output operation 1620.

In an embodiment, after performing the first sound signal output operation 1620, the electronic device 400 may perform the second sound signal output operation 1630.

In an embodiment, the electronic device 400 may output a second sound signal through the speaker unit 420 for a specified time in the second sound signal output operation 1630. The second sound signal may be a different signal from the first sound signal (e.g., the first sound 1000 or the second sound 1100). For example, the first sound signal may be a sound in an audible frequency range which a human being is able to hear, and the second sound signal may be a sound in an inaudible frequency range which a human being is unable to hear.

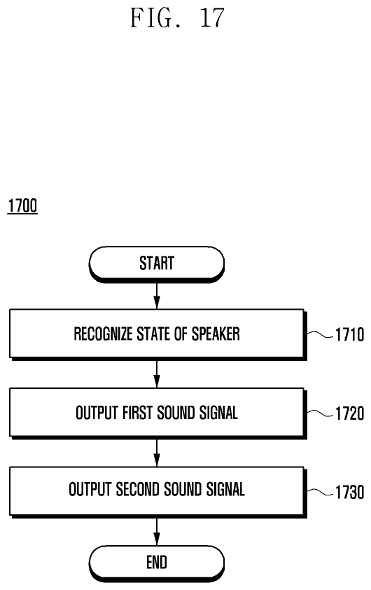

FIG. 17 illustrates a speaker state-based sound signal output method 1700.

In an embodiment, the speaker state-based sound signal output method 1700 may be performed, for example, according to a flowchart illustrated in FIG. 17. Since the flowchart illustrated in FIG. 17 is merely a flowchart of the speaker state-based sound signal output method 1700 according to an embodiment, the order of operations may be changed, or operations may be performed simultaneously.

In an embodiment, each operation of the speaker state-based sound signal output method 1700 may be performed under control of a processor (e.g., the processor 120 of FIG. 1) of an electronic device 400.

In an embodiment, the speaker state-based sound signal output method 1700 may include a speaker state recognition operation 1710, a first sound signal output operation 1720, and/or a second sound signal output operation 1730.

In an embodiment, the electronic device 400 may recognize the state of a speaker unit 420 in the speaker state recognition operation 1710. The state of the speaker unit 420 may include the age of a speaker (e.g., a first speaker 421), the output state of the speaker (e.g., the first speaker 421), and/or the state of a component (e.g., the degree of damage to a diaphragm) included in the speaker (e.g., the first speaker 421). For example, in the operation 1710, the electronic device 400 may recognize how much time has passed since the speaker 421 was manufactured. For example, in the operation 1710, the electronic device 400 may recognize whether the output of the speaker 421 according to a predetermined input is formed at a predetermined level. For example, in the operation 1710, the electronic device 400 can recognize whether a component included in the speaker unit 420 is damaged or aged beyond a determined criterion.

In an embodiment, the electronic device 400 may perform the speaker state recognition operation 1710 after performing the sound signal output function execution operation 1310 of FIG. 13, the sound signal output function execution operation 1410 of FIG. 14, or the foreign substance detection operation 1510 of FIG. 15. For example, in an embodiment, after being configured to perform a function of outputting an sound signal to remove a foreign substance having flowed into a passage 415 through the sound signal output function execution operations 1310 and 1410, the electronic device 400 may perform the speaker state recognition operation 1710 to recognize the state of the speaker (e.g., the first speaker 421). Alternatively, in an embodiment, the electronic device 400 may detect, using a sensor, that a foreign substance is in proximity to a passage 415 or the speaker unit 420 through the foreign substance detection operation 1510, and then perform the speaker state recognition operation 1710 to recognize the state of the speaker (e.g., the first speaker 421).

In an embodiment, the electronic device 400 may output a first sound signal through the speaker unit 420 for a specified time in the first sound signal output operation 1720. In an embodiment, the first sound signal may include at least one sound. For example, the first sound signal may include a first sound 1000 and/or a second sound 1100.

In an embodiment, the electronic device 400 may perform the first sound signal output operation 1720, based at least in part on the speaker state recognition operation 1710.

In an embodiment, the speaker unit 420 of the electronic device 400 may be configured to output a sound such that a frequency range or a sound level is adjusted based at least in part on the state of the speaker recognized in the speaker state recognition operation 1710 in the first sound signal output operation 1720. For example, the speaker unit 420 may be configured to output the first sound 1000 and/or the second sound 1100 such that at least one of a first frequency range fr1 or a second frequency range fr2 is adjusted based at least in part on the state of the speaker (e.g., the age of the speaker or the output level of the speaker) of the electronic device 400 recognized in the speaker state recognition operation 1710 in the first sound signal output operation 1720. Alternatively, the speaker unit 420 may be configured to output the first sound 1000 and/or the second sound 1100 such that the level of at least one of the first sound 1000 and/or the second sound 1100 is adjusted based at least in part on the state of the speaker (e.g., the age of the speaker or the output level of the speaker) recognized in the speaker state recognition operation 1710 in the first sound signal output operation 1720.

In an embodiment, the speaker unit 420 may be configured to increase or decrease the specified time for which the first sound signal (e.g., the first sound 1000 and/or the second sound 1100) is output, based at least in part on the state of the speaker (e.g., the age of the speaker or the output level of the speaker) recognized in the speaker state recognition operation 1710 in the first sound signal output operation 1720.

In an embodiment, after performing the first sound signal output operation 1720, the electronic device 400 may perform the second sound signal output operation 1730.

In an embodiment, the electronic device 400 may output a second sound signal through the speaker unit 420 in the second sound signal output operation 1730. The second sound signal may be a different signal from the first sound signal (e.g., the first sound 1000 or the second sound 1100). For example, the first sound signal may be a sound in an audible frequency range which a human being is able to hear, and the second sound signal may be a sound in an inaudible frequency range which a human being is unable to hear.

In an embodiment, the second sound signal output operation 1730 may vary based on the state of the speaker. In an embodiment, the electronic device 400 may perform the second sound signal output operation 1730, based on the state of the speaker recognized in the speaker state recognition operation 1710. The electronic device 400 may be configured to vary the second sound signal output operation 1730 depending on the state of the speaker recognized in the speaker state recognition operation 1710. For example, when determining that the state of the speaker recognized in the speaker state recognition operation 1710 is higher than a predetermined criterion (e.g., the age of the speaker is longer than a predetermined criterion), the electronic device 400 may output the second sound signal according to a predetermined criterion or higher (e.g., output the second sound signal for a longer time) in the second sound signal output operation 1730.

Each operation of the sound signal output methods 1300, 1400, 1500, 1600, and 1700 according to an embodiment of the disclosure may be performed based on at least some of the components of the integrated intelligence system of FIG. 2 or FIG. 3. For example, the first sound signal output operations 1320, 1420, 1520, 1620, and 1720 may be performed based on an artificial intelligence (AI) system generated by the planner module 325 (see FIG. 2). For example, the speaker unit 420 may be configured to adjust the level of at least one of the first sound 1000 or the second sound 1100 by using the AI system generated by the planner module 325 (see FIG. 2) in the first sound signal output operations 1320, 1420, 1520, 1620, and 1720.

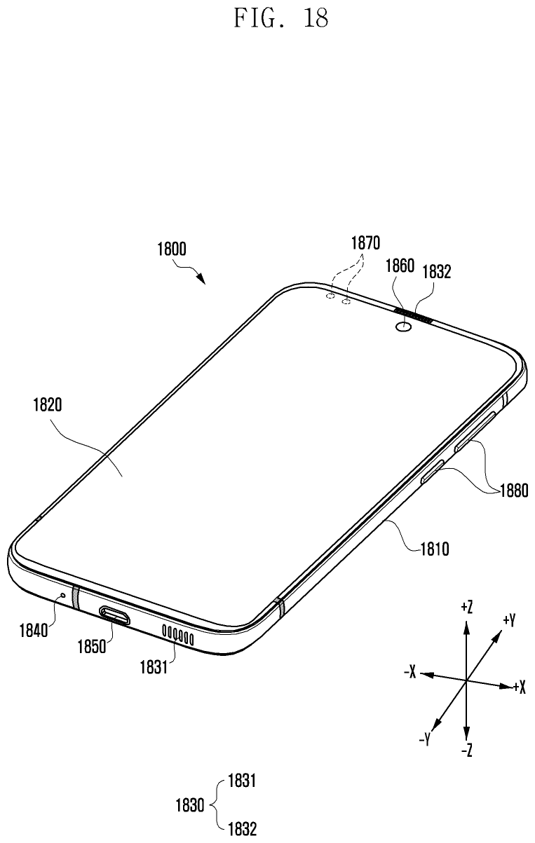

FIG. 18 illustrates an electronic device 1800 according to an embodiment of the disclosure.

The electronic device 1800 according to an embodiment of the disclosure may include a housing 1810, a display 1820, a speaker unit 1830, an input device 1840, a connection unit 1850, a camera module 1860, a sensor module 1870, and/or a key input device 1880.

In an embodiment, the housing 1810 may be a component which forms the exterior of the electronic device 1800. The housing 1810 may be a component forming the exterior of the electronic device 1800 and surrounding an electronic component (e.g., a printed circuit board or a battery) disposed inside the electronic device 1800.

In an embodiment, the display 1820 may serve to visually provide information to the outside (e.g., a user) of the electronic device 1800.

In an embodiment, the input device 1840 may be a device configured to input a sound-based signal into the electronic device 1800. The input device 1840 may include a microphone device for inputting a sound.

In an embodiment, the connection unit 1850 may include a connector port configured to connect the electronic device 1800 and an external device.

In an embodiment, the camera module 1860 may include at least one lens, an image sensor, and/or an image signal processor.

In an embodiment, the sensor module 1870 may obtain or generate an electrical signal or a data value corresponding to an internal operating state or an external environmental state of the electronic device 1800.

In an embodiment, the key input device 1880 may be a device configured to input a pressure-based signal into the electronic device 1800. For example, the user of the electronic device 1800 may apply pressure to the electronic device 1800 through the key input device 1880.

In an embodiment, the speaker unit 1830 may include a first speaker 1831 and/or a second speaker 1832. The first speaker 1831 and the second speaker 1832 may be devices configured to output a sound to the outside of the electronic device 1800.

In an embodiment, the speaker unit 1830 may refer to the speaker unit 420 of FIG. 6A, or may include at least some of the components of the speaker unit 420 of FIG. 6A.

In an embodiment, the first speaker 1831 and the second speaker 1832 may be disposed in different positions.

In an embodiment, the speaker unit 1830 may output a sound for removing a foreign substance flowing into the electronic device 1800. For example, the speaker unit 1830 may output a first sound 1000 (see FIGS. 10A to 10D) and/or a second sound 1100 (see FIGS. 11A to 11D) to remove a foreign substance flowing into the electronic device 1800.

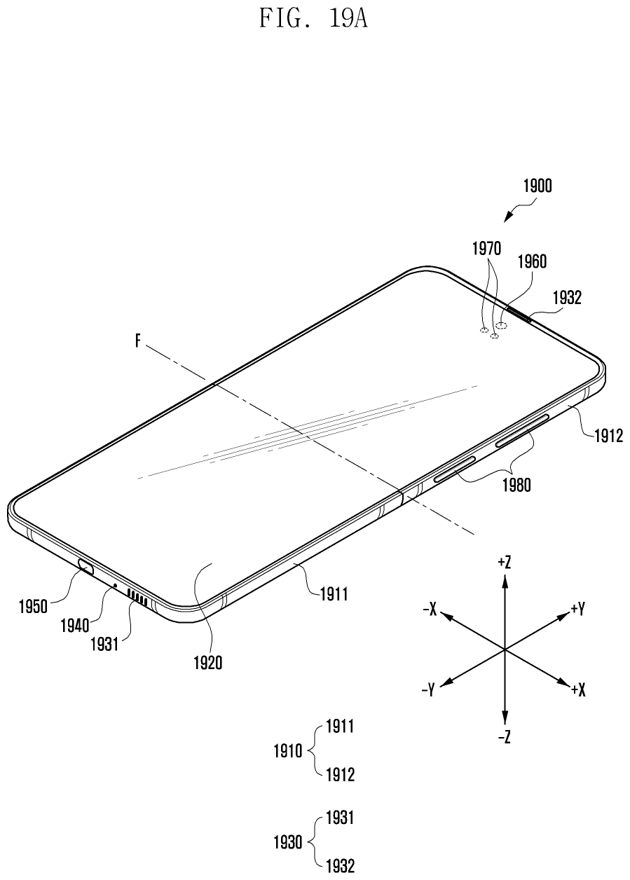

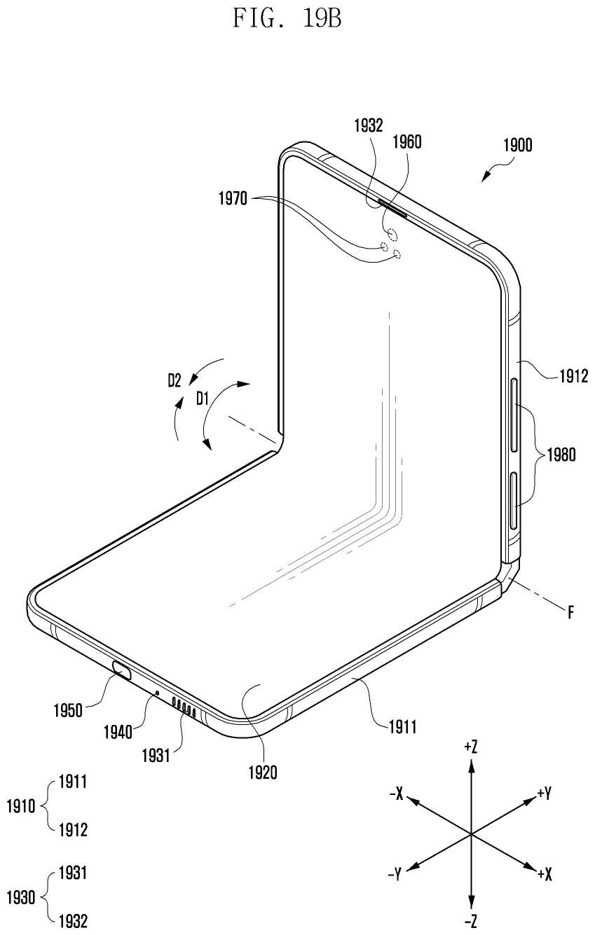

FIG. 19A and FIG. 19B illustrate an electronic device 1900 according to an embodiment of the disclosure.

FIG. 19A illustrates a state in which the electronic device 1900 is unfolded according to an embodiment. FIG. 19B illustrates a state in which the electronic device 1900 is folded at a certain angle according to an embodiment.

Referring to FIG. 19A and FIG. 19B, the electronic device 1900 according to an embodiment may be a foldable electronic device capable of being unfolded or folded around a folding axis F.

In an embodiment, the electronic device 1900 may include a housing 1910, a display 1920, a speaker unit 1930, an input device 1940, a connection unit 1950, a camera module 1960, a sensor module 1970, and/or a key input device 1980.

In an embodiment, the housing 1910 may be a component which forms the exterior of the electronic device 1900. The housing 1910 may be a component forming the exterior of the electronic device 1900 and surrounding an electronic component (e.g., a printed circuit board or a battery) disposed inside the electronic device 1900.

In an embodiment, the housing 1910 may include a first housing 1911 and/or a second housing 1912.

In an embodiment, the first housing 1911 and the second housing 1912 may be foldably coupled to each other.

In an embodiment, the electronic device 1900 may be unfolded or folded around the folding axis F. When force in an unfolding direction D1 is applied to the electronic device 1900, the electronic device 1900 may be switched to an unfolded state (e.g., a state in which the first housing 1911 and the second housing 1912 are disposed substantially on the same plane). When force in a folding direction D2 is applied to the electronic device 1900, the electronic device 1900 may be switched to the folded state (e.g., a state in which the first housing 1911 and the second housing 1912 are disposed while being folded).

In an embodiment, the display 1920 may serve to visually provide information to the outside (e.g., a user) of the electronic device 1900.

In an embodiment, the display 1920 may be a flexible display which is at least partly bendable.

In an embodiment, the input device 1940 may be a device configured to input a sound-based signal into the electronic device 1900. The input device 1940 may include a microphone device for inputting a sound.

In an embodiment, the connection unit 1950 may include a connector port configured to connect the electronic device 1900 and an external device.

In an embodiment, the camera module 1960 may include at least one lens, an image sensor, and/or an image signal processor.

In an embodiment, the sensor module 1970 may obtain or generate an electrical signal or a data value corresponding to an internal operating state or an external environmental state of the electronic device 1900.

In an embodiment, the key input device 1980 may be a device configured to input a pressure-based signal into the electronic device 1900. For example, the user of the electronic device 1900 may apply pressure to the electronic device 1900 through the key input device 1980.

In an embodiment, the speaker unit 1930 may include a first speaker 1931 and/or a second speaker 1932. The first speaker 1831 and the second speaker 1932 may be devices configured to output a sound to the outside of the electronic device 1900.

In an embodiment, the speaker unit 1930 may refer to the speaker unit 420 of FIG. 6A, or may include at least some of the components of the speaker unit 420 of FIG. 6A.

In an embodiment, the first speaker 1931 and the second speaker 1932 may be disposed in different positions. For example, the first speaker 1931 may be disposed in the first housing 1911. The second speaker 1932 may be disposed in the second housing 1912.

In an embodiment, the speaker unit 1930 may output a sound for removing a foreign substance flowing into the electronic device 1900. For example, the first speaker 1931 and/or the second speaker 1932 may output a first sound 1000 (see FIGS. 10A to 10D) and/or a second sound 1100 (see FIGS. 11A to 11D) to remove a foreign substance flowing into the electronic device 1900.

In an embodiment, the first speaker 1931 and/or the second speaker 1932 may be configured to adjust and output a sound, based at least in part on a change in the relative position of the second housing 1912 with respect to the first housing 1911. For example, the first speaker 1931 and/or the second speaker 1932 may adjust and output a sound in a predetermined form when the first housing 1911 and the second housing 1912 are overlapped or when the first housing 1911 and the second housing 1912 are positioned substantially on the same plane.

In an embodiment, the first speaker 1931 and/or the second speaker 1932 may be configured to output the first sound 1000 and/or the second sound 1100 such that at least one of a first frequency range fr1 or a second frequency range fr2 is adjusted based at least in part on the change in the relative position of the second housing 1912 with respect to the first housing 1911. For example, the first speaker 1931 and/or the second speaker 1932 may be configured to output the first sound 1000 or the second sound 1100 by partly adjusting at least one of the first frequency range fr1 or the second frequency range fr2 when the first housing 1911 and the second housing 1912 are overlapped. For example, the first speaker 1931 and/or the second speaker 1932 may reduce or increase at least one of the first frequency range fr1 or the second frequency range fr2 when the electronic device 1900 is in the folded state, compared to when the electronic device 1900 is in the unfolded state.

In an embodiment, the first speaker 1931 and/or the second speaker 1932 may be configured to output the first sound 1000 and/or the second sound 1100 such that the level (e.g., sound pressure) of at least one of the first sound 1000 or the second sound 1100 is adjusted based at least in part on the change in the relative position of the second housing 1912 with respect to the first housing 1911. For example, the first speaker 1931 and/or the second speaker 1932 may be configured to output at least one of the first sound 1000 or the second sound 1100 by increasing or reducing the level (e.g., sound pressure) thereof when the first housing 1911 and the second housing 1912 are overlapped.

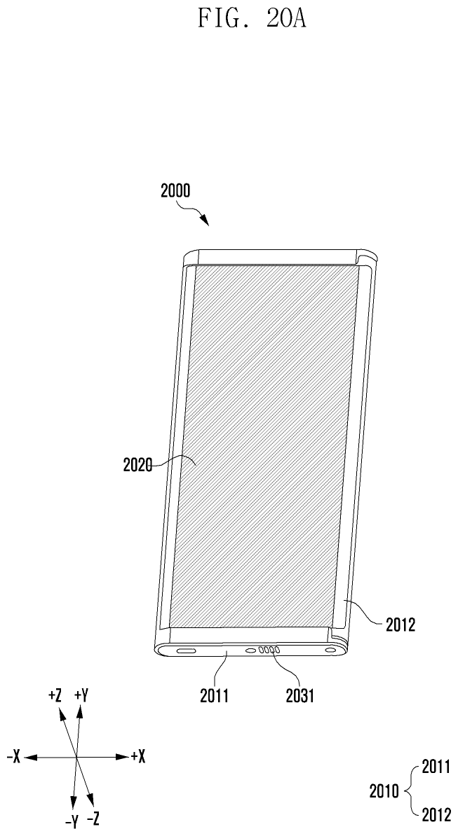

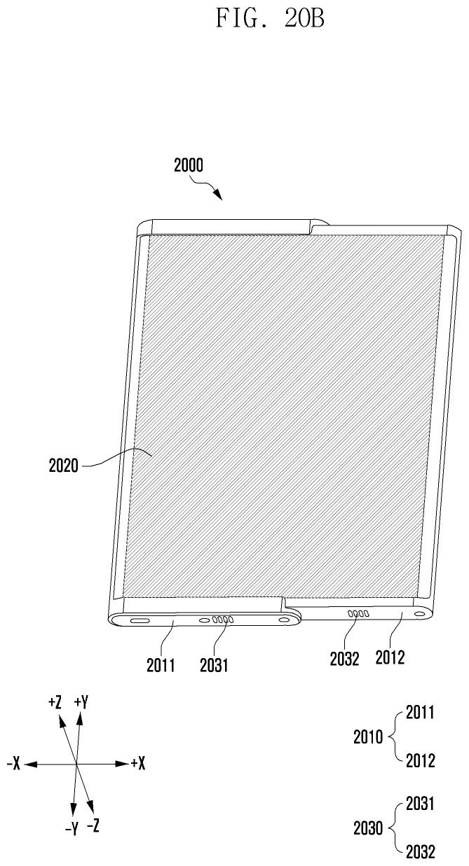

FIG. 20A and FIG. 20B illustrate an electronic device 2000 according to an embodiment of the disclosure.

The electronic device 2000 according to an embodiment of the disclosure may include a housing 2010, a display 2020, and/or a speaker unit 2030.

In an embodiment, the housing 2010 may be a component which forms the exterior of the electronic device 2000. The housing 2010 may be a component forming the exterior of the electronic device 2000 and surrounding an electronic component (e.g., a printed circuit board or a battery) disposed inside the electronic device 2000.

In an embodiment, the housing 2010 may include a first housing 2011 and/or a second housing 2012.

In an embodiment, the second housing 2012 may be coupled to the first housing 2011 to be movable with respect to the first housing 2011. For example, the second housing 2012 may be slidable such that one side of the second housing 2012 moves away from or toward the first housing 2011.

In an embodiment, the display 2020 may serve to visually provide information to the outside (e.g., a user) of the electronic device 2000.

In an embodiment, the display 2020 may be a flexible display which is at least partly bendable.

In an embodiment, when the one side of the second housing 2012 slides away from the first housing 2011, an area displayed externally on the display 2020 may increase.

In an embodiment, when the one side of the second housing 2012 slides toward the first housing 2011, an area displayed externally on the display 2020 may decrease.

In an embodiment, the speaker unit 2030 may include a first speaker 2031 and/or a second speaker 2032.

In an embodiment, the first speaker 2031 and the second speaker 2032 may be disposed in different positions. For example, the first speaker 2031 may be accommodated in the first housing 2011. The second speaker 2032 may be accommodated in the second housing 2012.

In an embodiment, the speaker unit 2030 may output a sound for removing a foreign substance flowing into the electronic device 2000. For example, the first speaker 2031 and/or the second speaker 2032 may output a first sound 1000 (see FIGS. 10A to 10D) and/or a second sound 1100 (see FIGS. 11A to 11D).

In an embodiment, the first speaker 2031 and/or the second speaker 2032 may be configured to adjust and output a sound, based at least in part on a change in the relative position of the second housing 2012 with respect to the first housing 2011. For example, the first speaker 2031 and/or the second speaker 2032 may adjust and output a sound in a predetermined form when the one side of the second housing 2012 slides away from the first housing 2011 or the one side of the second housing 2012 slides toward the first housing 2011.

In an embodiment, the first speaker 2031 and/or the second speaker 2032 may be configured to output the first sound 1000 and/or the second sound 1100 such that at least one of a first frequency range fr1 or a second frequency range fr2 is adjusted based at least in part on the change in the relative position of the second housing 2012 with respect to the first housing 2011. For example, the first speaker 2031 and/or the second speaker 2032 may be configured to output the first sound 1000 or the second sound 1100 by partly adjusting at least one of the first frequency range fr1 or the second frequency range fr2 when the one side of the second housing 2012 slides away from the first housing 2011.

In an embodiment, the first speaker 2031 and/or the second speaker 2032 may be configured to output at least one of the first sound 1000 or the second sound 1100 by adjusting the level (e.g., sound pressure) thereof, based at least in part on the change in the relative position of the second housing 2012 with respect to the first housing 2011. For example, the first speaker 2031 and/or the second speaker 2032 may be configured to output at least one of the first sound 1000 or the second sound 1100 by increasing or reducing the level (e.g., sound pressure) thereof when the one side of the second housing 2012 slides away from the first housing 2011.

When a sound passage is formed in a structure which makes it difficult to remove water, even though a speaker outputs a functional sound for removing water, it may be difficult to remove water having flowed into the sound passage. Further, when a plurality of speakers shares one sound passage, even though the speakers output a functional sound for removing water, it may be difficult to remove water having flowed into the sound passage.

Therefore, when a sound passage is formed in a structure which makes it difficult to remove water and when a plurality of speakers shares one sound passage, a configuration capable of removing water having flowed into a sound passage may be required.

An electronic device 400 according to an embodiment of the disclosure may include a housing 410 and a plurality of speakers 421 and 422. The housing 410 may include at least one passage 415. The plurality of speakers 421 and 422 may be configured to output a sound to the outside of the electronic device 400 through the at least one passage.

In an embodiment, the plurality of speakers 421 and 422 may be configured to simultaneously output a first sound 1000 corresponding to a first frequency range fr1 and a second sound 1100 corresponding to a second frequency range fr2 different from the first frequency range fr1, based on the occurrence of an event for removing a foreign substance in the passage 415 or in proximity to the speakers 421 and 422.

In an embodiment, the first frequency range fr1 may be associated with a resonance frequency of a first speaker 421 of the plurality of speakers 421 and 422, and the second frequency range fr2 may be associated with a resonance frequency of a second speaker 422 of the plurality of speakers 421 and 422.

In an embodiment, the electronic device includes a housing defining an audio passage which is exposed to outside of the electronic device and along which a foreign substance is moveable both away from and toward the outside of the electronic device. and a speaker in audio communication with the audio passage and configured to output a sound into the audio passage. The speaker is provided in plural including a first speaker having a resonance frequency corresponding to a first frequency range, and a second speaker having a resonance frequency corresponding to a second frequency range different from the first frequency range. Each of the speakers is configured to simultaneously output a first sound corresponding to the first frequency range and a second sound corresponding to the second frequency range as the sound which is output into the audio passage. The each of the speakers simultaneously outputting the first sound and the second sound both corresponds to the foreign substance being within the audio passage and moves the foreign substance which is within the audio passage along the audio passage and toward the outside of the electronic device.

In an embodiment, the first sound 1000 may include a plurality of sub sounds having different frequencies. The plurality of speakers 421 and 422 may be configured to output one of the plurality of sub sounds of the first sound 1000 at a sound pressure greater than that of the remaining sub sounds of the first sound 1000.

In an embodiment, the first sound may include sub sounds with different frequencies. The each of the speakers may be configured to output the first sound including a sound pressure of one of the sub sounds of the first sound which is greater than a sound pressure of the remaining sub sounds of the first sound.

In an embodiment, the plurality of sub sounds of the first sound 1000 may include a first sub sound 1010, a second sub sound 1020, a third sub sound 1030, and a fourth sub sound 1040 having the different frequencies. The plurality of speakers 421 and 422 may be configured such that the first sub sound 1010, the second sub sound 1020, the third sub sound 1030, and the fourth sub sound 1040 each are alternately output at a sound pressure greater than that of the other sub sounds.

In an embodiment, the plurality of speakers 421 and 422 may be configured to output each of the first sub sound 1010, the second sub sound 1020, the third sub sound 1030, and the fourth sub sound 1040 at a first sound pressure P1 or greater, and to output one of the first sub sound 1010, the second sub sound 1020, the third sub sound 1030, and the fourth sub sound 1040 at a second sound pressure P2 greater than the first sound pressure P1.

In an embodiment, the each of the speakers may be configured to output the first sound at different times, and each respective first sound among the first sounds may include one sub sound among the first sub sound, the second sub sound, the third sub sound and the fourth sub sound which has the sound pressure greater than the sound pressure of the remaining sub sounds of the respective first sound. The each of the speakers may be configured to alternately output the first sub sound, the second sub sound, the third sub sound and the fourth sub sound as the one sub sound of the first sound which has the sound pressure greater than the sound pressure of the remaining sub sounds of the first sound.

In an embodiment, the second sound 1100 may include a plurality of sub sounds having different frequencies. The plurality of speakers 421 and 422 may be configured to output one of the plurality of sub sounds of the second sound 1100 at a sound pressure greater than that of the remaining sub sounds of the second sound 1100.

In an embodiment, the plurality of sub sounds of the second sound 1100 may include a fifth sub sound 1110, a sixth sub sound 1120, a seventh sub sound 1130, and an eighth sub sound 1140 having different frequencies. The plurality of speakers 421 and 422 may be configured such that the fifth sub sound 1110, the sixth sub sound 1120, the seventh sub sound 1130, and the eighth sub sound 1140 each are alternately output at a sound pressure greater than that of the other sub sounds.

In an embodiment, the plurality of speakers 421 and 422 may be configured to output each of the fifth sub sound 1110, the sixth sub sound 1120, the seventh sub sound 1130, and the eighth sub sound 1140 at a third sound pressure P3 or greater, and to output one of the fifth sub sound 1110, the sixth sub sound 1120, the seventh sub sound 1130, and the eighth sub sound 1140 at a fourth sound pressure P4 greater than the third sound pressure P3.

In an embodiment, the each of the speakers may be configured to output the second sound at different times, and each respective second sound among the second sounds includes one sub sound among the fifth sub sound, the sixth sub sound, the seventh sub sound and the eighth sub sound which has the sound pressure greater than the sound pressure of the remaining sub sounds of the respective second sound. The each of the speakers may be configured to alternately output the fifth sub sound, the sixth sub sound, the seventh sub sound and the eighth sub sound as the one sub sound of the second sound which has the sound pressure greater than the sound pressure of the remaining sub sounds of the second sound.

In an embodiment, the electronic device 400 may include a processor 120 configured to identify a specified user input as an occurrence of the event.

In an embodiment, the plurality of the speaker 421 and 422 may be configured to output the first sound 1000 and the second sound 1100 simultaneously, based at least in part on the specified user input.

In an embodiment, the processor may be configured to identify a user input to the electronic device which corresponds to a function of removing the foreign substance from within the audio passage, and the each of the speakers simultaneously outputting the first sound and the second sound may further correspond to the user input. Here, identification of the user input defines an event of the electronic device which affects removal of the foreign substance from within the audio passage. The each of the speakers simultaneously outputting the first sound and the second sound is a response to the event of the electronic device, that is, the each of the speakers simultaneously outputting the first sound and the second sound may be considered as corresponding to or being a direct result of the user input event.

In an embodiment, the electronic device 400 may include a sensor configured to detect that the foreign substance is in the passage 415 or in proximity to the speakers 421 and 422. In an embodiment, the plurality of the speakers 421 and 422 may be configured to output the first sound 1000 and the second sound 1100 simultaneously, based at least in part on insertion of the foreign substance in the passage 415 or in proximity to the speakers 421 and 422.

In an embodiment, the sensor may be configured to detect the foreign substance in the audio passage or in proximity to one or more of the speakers, and the each of the speakers simultaneously outputting the first sound and the second sound may further correspond to detection by the sensor of the foreign substance being in the audio passage or being in proximity to the one or more of the speakers. Here, detection by the sensor of the foreign substance in the audio passage or in proximity to one or more of the speakers defines an event of the electronic device which affects removal of the foreign substance from within the audio passage. The each of the speakers simultaneously outputting the first sound and the second sound is a response to the event of the electronic device, that is, the each of the speakers simultaneously outputting the first sound and the second sound may be considered as corresponding to or being a direct result of the foreign substance detection event.

In an embodiment, the electronic device 400 may include a measurement sensor configured to measure the amount of the foreign substance in the passage 415 or in proximity to the speakers 421 and 422. The plurality of the speakers 421 and 422 may be configured to adjust the sound pressure of at least one of the first sound 1000 or the second sound 1100, based at least in part on the amount of the foreign substance measured by the measurement sensor.

In an embodiment, the measurement sensor may be configured to measure an amount of the foreign substance which is in the audio passage or is in proximity to one or more of the speakers. The each of the speakers may be configured to adjust a sound pressure of at least one of the first sound and the second sound. Measurement by the measurement sensor of the amount of the foreign substance which is in the audio passage or is in proximity to one or more of the speakers defines an event of the electronic device which affects removal of the foreign substance from within the audio passage. The each of the speakers adjusting the sound pressure of the at least one of the first sound and the second sound is a response to the event of the electronic device, that is, the each of the speakers adjusting the sound pressure of the at least one of the first sound and the second sound may be considered as corresponding to or being a direct result of the amount of foreign substance detection event.

In an embodiment, the electronic device 400 may include a vibration actuator. The vibration actuator may be configured to generate vibrations while the first sound 1000 or the second sound 1100 is output through the plurality of the speakers 421 and 422.

In an embodiment, a vibrator may be configured to generate vibrations within the electronic device, and output of the first sound or the second sound by the each of the speakers may correspond to generation of the vibrations by the vibrator. That is, the vibrator may generate the vibrations at a same time, as a direct result of, etc. the each of the speakers outputting the first sound or the second sound.

In an embodiment, the at least one passage 415 may include a common passage 4153 corresponding to each of the first speaker 421 and the second speaker 422. The first speaker 421 and second speaker 422 may be configured to output the first sound 1000 and the second sound 1100 simultaneously, based at least in part on insertion of the foreign substance in the common passage 4153.

In an embodiment, the audio passage may include a common passage corresponding to each of the first speaker and the second speaker and through which respective sounds of the first speaker and the second speaker pass. The each of the speakers simultaneously outputting the first sound and the second sound may further move the foreign substance which is in the common passage along the common passage and toward the outside of the electronic device.

In an embodiment, the housing 410 may include a first housing 1911 and 2011 and a second housing 1912 and 2012. The first speaker 421 may be disposed in the first housing 1911 and 2011. The second speaker 422 may be disposed in the second housing 1911 and 2011.

In an embodiment, the first speaker 421 or the second speaker 422 may be configured to adjust the sound pressure of at least one of the first sound 1000 or the second sound 1100, based at least in part on a change in relative position of the first housing 1911 and 2011 and the second housing 1912 and 2012.

In an embodiment, the first speaker or the second speaker may be configured to adjust a sound pressure of at least one of the first sound and the second sound. The housing may include a first housing and a second housing moveably connected to each other, where a relative position of the first housing to the second housing being changeable. The first speaker may be in the first housing and the second speaker may be in the second housing, Adjustment of the sound pressure of the at least one of the first sound and the second sound by the first speaker or the second speaker may correspond to a change in the relative position.

An electronic device 400 according to an embodiment of the disclosure may include a housing 410 and a speaker 421. The housing 410 may include a passage 415 formed therein. The speaker 421 may be configured to output a sound to the outside of the electronic device 400 through the passage 415.

In an embodiment, the speaker 421 may be configured to perform an operation of outputting a first sound 1000 corresponding to a first frequency range fr1 and a second sound 1100 corresponding to a second frequency range fr2, which is at least partly different from the first frequency range fr1, for a specified time such that a foreign substance in the passage 415 or in proximity to the speaker 421 is at least partly removed based at least in part on a specified condition being satisfied.

In an embodiment, an electronic device includes a housing defining an audio passage which is exposed to outside of the electronic device and along which a foreign substance is moveable both away from and toward the outside of the electronic device, and a speaker configured to output a sound into the audio passage. The sound includes a first sound corresponding to a first frequency range, and a second sound corresponding to a second frequency range which is at least partly different from the first frequency range, for a time period, The speaker simultaneously outputting the first sound and the second sound for the time period both corresponds to the foreign substance being in the audio passage or being in proximity to the speaker along the audio passage and moves the foreign substance which is in the audio passage or is in proximity to the speaker along the audio passage and toward the outside of the electronic device.

The electronic device 400 according to an embodiment of the disclosure may effectively remove a foreign substance flowing into the passage 415 by using a sound output from the speaker 421.

The electronic device 400 according to an embodiment of the disclosure may effectively remove a foreign substance flowing into the passage 415 even when a plurality of speakers shares the same passage 415.

The electronic device 400 according to an embodiment of the disclosure may improve the sound performance of a speaker by removing a foreign substance flowing into the passage 415.

In an embodiment, the speaker 421 may be configured to perform an output operation such that the first sound 1000 and the second sound 1100 are simultaneously output.

In an embodiment, the speaker 421 may be configured to perform an operation of outputting the first sound 1000 such that a frequency corresponding to a predetermined sound pressure P2 and P4 discontinuously increases or decreases within the first frequency range fr1 and outputting the second sound such that the frequency corresponding to the predetermined sound pressure P2 and P4 discontinuously increases or decreases within the second frequency range fr2.

In an embodiment, the speaker 421 may be configured to perform an operation of outputting the first sound 1000 such that the frequency corresponding to the predetermined sound pressure P2 and P4 continuously increases or decreases within the first frequency range fr1 and outputting the second sound 1100 such that the frequency corresponding to the predetermined sound pressure P2 and P4 continuously increases or decreases within the second frequency range fr2.

In an embodiment, the speaker 421 may be configured to perform an operation of outputting one of the first sound 1000 and the second sound 1100 such that the frequency corresponding to the predetermined sound pressure P2 and P4 discontinuously increases or decreases within a corresponding frequency range of the first frequency range fr1 and the second frequency range fr2 and outputting the other of the first sound 1000 and the second sound 1100 such that the frequency corresponding to the predetermined sound pressure P2 and P4 continuously increases or decreases within another corresponding frequency range of the first frequency range fr1 and the second frequency range fr2.

In an embodiment, the speaker 421 may be configured to perform an operation of outputting a sound such that at least one of the first frequency range fr1 or the second frequency range fr2 or the level of at least one of the first sound 1000 or the second sound 1100 is adjusted based at least in part on the amount of the foreign substance.

In an embodiment, the speaker 421 may be configured to perform an operation of outputting a sound such that at least one of the first frequency range fr1 or the second frequency range fr2 or the level of at least one of the first sound 1000 or the second sound 1100 is adjusted based at least in part on the surrounding environment of the electronic device 400.

In an embodiment, the speaker 421 may be configured to perform an operation of outputting a sound such that at least one of the first frequency range fr1 or the second frequency range fr2 or the level of at least one of the first sound 1000 or the second sound 1100 is adjusted based at least in part on the state of the speaker 421.

In an embodiment, the speaker 421 may be configured to perform an operation of outputting a sound such that the specified time increases or decreases based at least in part on the amount of the foreign substance, the surrounding environment of the electronic device 400, or the state of the speaker 421.

In an embodiment, the electronic device 400 may include another speaker (e.g., a second speaker 422).

In an embodiment, the other speaker (e.g., the second speaker 422) may be configured to perform an operation of outputting a third sound S3 corresponding to the first frequency range fr1 and a fourth sound S4 corresponding to the second frequency range fr2 for a specified time while the speaker 421 performs the output operation.

In an embodiment, the housing 410 may include another passage (e.g., a second passage 4152) through which the other speaker 422 outputs a sound to the outside.

In an embodiment, the other passage (e.g., the second passage 4152) may include at least a portion of a common area (e.g., the common passage 4153) with the passage (e.g., a first passage 4151), and the other speaker 422 may be configured to perform the operation of outputting the third sound S3 and the fourth sound S4, based at least in part on the foreign substance being in the common area.

In an embodiment, the speaker 1931 and 2031 and the other speaker 1932 and 2032 may be accommodated in the first housing 1911 and 2011 and the second housing 1912 and 2012, respectively.

In an embodiment, the speaker 1931 and 2031 or the other speaker 1932 and 2032 may be configured to perform an output operation such that at least one of the first frequency range fr1 or the second frequency range fr2, the level of at least one of the first sound or the second sound, or the level of at least one of the third sound or the fourth sound is adjusted based at least in part on a change in the relative position of the first housing 1911 and 2011 and the second housing 1912 and 2012.

An electronic device 400 according to an embodiment of the disclosure may include a first speaker 421, a passage 415, a processor 120, and a memory 130. The passage 415 may be formed around the first speaker 421. The memory 130 may be operatively connected to the processor 120.

In an embodiment, the memory 130 may store an instruction which, when executed by the processor 120, causes the electronic device 400 to output a first sound 1000 including a plurality of sub sounds 11010, 1020, 1030, and 1040 with different frequencies in a first frequency range fr1 at a predetermined sound pressure through the first speaker 421, and temporarily increase the sound pressures of the respective sub sounds included in the first sound 1000 in a predetermined order.

In an embodiment, an electronic device includes an audio passage which is exposed to outside of the electronic device, a first speaker which is in audio connection with the audio passage, a processor, and a memory which is operatively connected to the processor and stores a first instruction executable by the processor. The first instruction which is executed includes the first speaker outputting a first sound including sub sounds with different frequencies in a first frequency range and each having a sound pressure, and the first speaker temporarily increasing the sound pressure of respective sub sounds of the first sound, at different times, in an order of the different times.

In an embodiment, the first speaker 421 may have a first resonance frequency, and the first frequency range fr1 may correspond to the first resonance frequency.

In an embodiment, the electronic device 400 may include a second speaker 422 at least partly connected with the passage 415.

In an embodiment, the memory 130 may store an instruction which, when executed by the processor 120, causes the electronic device 400 to output the first sound 1000 and a second sound 1100 including a plurality of sub sounds 1110, 1120, 1130, and 1140 with different frequencies in a second frequency range fr2 at a predetermined sound pressure through the first speaker 421 and the second speaker 422, and temporarily increase the sound pressures of the respective sub sounds included in the first sound 1000 and the sound pressures of the respective sub sounds included in the second sound 1100 in a predetermined order.

In an embodiment, where the electronic device may include a second speaker in audio connection with the audio passage. The first instruction which is executed may further include each of the first speaker and the second speaker outputting the first sound simultaneously with outputting a second sound including sub sounds with different frequencies in a second frequency range and each having a sound pressure, and the each of the first speaker and the second speaker temporarily increasing the sound pressure of the respective sub sounds of the first sound and respective sub sounds of the second sound, at the different times, in the order of the different times.

In an embodiment, the memory 130 may store an instruction which, when executed by the processor 120, causes the electronic device to play a sound having a frequency in an inaudible range through the first speaker 421. Here, the memory may further store a second instruction executable by the processor, and the second instruction which is executed may include the first speaker playing a sound having a frequency in an inaudible range.

In an embodiment, the electronic device 400 may include a partition wall 418 surrounding at least a portion of the passage 415. In an embodiment, one surface 418A of the partition wall 418 may be formed in an inclined shape with respect to one surface 420A of the first speaker 421 or the second speaker 422.

In an embodiment, the housing may include an inner surface which faces a speaker and defines the audio passage. The respective speaker includes a speaker surface facing the inner surface of the housing, and the inner surface of the housing is inclined with respect to the speaker surface.

Technical aspects to be achieved in the disclosure are not limited to the technical aspects mentioned above, and other technical aspects not mentioned will be clearly understood by those skilled in the art from the following description.

Effects obtainable from the disclosure are not limited to the effects mentioned above, and other effects not mentioned will be clearly understood by those skilled in the art to which the disclosure pertain.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements.

It is to be understood that a singular form of a noun corresponding to an item may include one or more of the things, unless the relevant context clearly indicates otherwise. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

As used herein, such terms as “1st” and “2nd,” or “first” and “second” may be used to simply distinguish a corresponding component from another, and does not limit the components in other aspect (e.g., importance or order).

It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element. In contrast, when an element is referred to such as being “directly coupled with,” “directly coupled to,” “directly connected with,” or “directly connected to” another element, no other element is therebetween.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below. [443]“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions which are stored in a storage medium (e.g., internal memory 136 or external memory 138) which is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration.

According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a housing defining an audio passage which is exposed to outside of the electronic device and along which a foreign substance is moveable both away from and toward the outside of the electronic device; and
a speaker in audio communication with the audio passage and configured to output a sound into the audio passage,
wherein
the speaker is provided in plural including:
a first speaker having a resonance frequency corresponding to a first frequency range, and
a second speaker having a resonance frequency corresponding to a second frequency range different from the first frequency range,
each of the speakers is configured to simultaneously output a first sound corresponding to the first frequency range and a second sound corresponding to the second frequency range as the sound which is output into the audio passage, and
the each of the speakers simultaneously outputting the first sound and the second sound both corresponds to the foreign substance being within the audio passage and moves the foreign substance which is within the audio passage along the audio passage and toward the outside of the electronic device.

2. The electronic device of claim 1, wherein
the first sound comprises sub sounds with different frequencies, and
the each of the speakers is configured to output the first sound including a sound pressure of one of the sub sounds of the first sound which is greater than a sound pressure of the remaining sub sounds of the first sound.

3. The electronic device of claim 2, wherein
the sub sounds of the first sound comprise a first sub sound, a second sub sound, a third sub sound and a fourth sub sound having the different frequencies,
the each of the speakers is configured to output the first sound at different times, and
each respective first sound among the first sounds includes one sub sound among the first sub sound, the second sub sound, the third sub sound and the fourth sub sound which has the sound pressure greater than the sound pressure of the remaining sub sounds of the respective first sound.

4. The electronic device of claim 3, wherein the each of the speakers is configured to alternately output the first sub sound, the second sub sound, the third sub sound and the fourth sub sound as the one sub sound of the first sound which has the sound pressure greater than the sound pressure of the remaining sub sounds of the first sound.

5. The electronic device of claim 1, wherein
the second sound comprises sub sounds with different frequencies, and
the each of the speakers is configured to output the second sound including a sound pressure of one of the sub sounds of the second sound which is greater than a sound pressure of the remaining sub sounds of the second sound.

6. The electronic device of claim 5, wherein
the sub sounds of the second sound comprise a fifth sub sound, a sixth sub sound, a seventh sub sound and an eighth sub sound having different frequencies,
the each of the speakers is configured to output the second sound at different times, and
each respective second sound among the second sounds includes one sub sound among the fifth sub sound, the sixth sub sound, the seventh sub sound and the eighth sub sound which has the sound pressure greater than the sound pressure of the remaining sub sounds of the respective second sound.

7. The electronic device of claim 6, wherein the each of the speakers is configured to alternately output the fifth sub sound, the sixth sub sound, the seventh sub sound and the eighth sub sound as the one sub sound of the second sound which has the sound pressure greater than the sound pressure of the remaining sub sounds of the second sound.

8. The electronic device of claim 1, further comprising a processor configured to identify a user input to the electronic device,
wherein
identification of the user input defines an event of the electronic device which affects removal of the foreign substance from within the audio passage, and
the each of the speakers simultaneously outputting the first sound and the second sound is a response to the event of the electronic device.

9. The electronic device of claim 1, further comprising a sensor configured to detect the foreign substance in the audio passage or in proximity to one or more of the speakers,
wherein
detection by the sensor of the foreign substance in the audio passage or in proximity to one or more of the speakers defines an event of the electronic device which affects removal of the foreign substance from within the audio passage, and
the each of the speakers simultaneously outputting the first sound and the second sound is a response to the event of the electronic device.

10. The electronic device of claim 1, further comprising a measurement sensor configured to measure an amount of the foreign substance which is in the audio passage or is in proximity to one or more of the speakers,
wherein
the each of the speakers is configured to adjust a sound pressure of at least one of the first sound and the second sound,
measurement by the measurement sensor of the amount of the foreign substance which is in the audio passage or is in proximity to one or more of the speakers defines an event of the electronic device which affects removal of the foreign substance from within the audio passage, and
the each of the speakers adjusting the sound pressure of the at least one of the first sound and the second sound is a response to the event of the electronic device.

11. The electronic device of claim 1, further comprising a vibrator configured to generate vibrations within the electronic device,
wherein output of the first sound or the second sound by the each of the speakers corresponds to generation of the vibrations by the vibrator.

12. The electronic device of claim 1, wherein
the audio passage includes a common passage corresponding to each of the first speaker and the second speaker and through which respective sounds of the first speaker and the second speaker pass, and
the each of the speakers simultaneously outputting the first sound and the second sound further moves the foreign substance which is in the common passage along the common passage and toward the outside of the electronic device.

13. The electronic device of claim 1, wherein
the first speaker or the second speaker is configured to adjust a sound pressure of at least one of the first sound and the second sound,
the housing comprises a first housing and a second housing moveably connected to each other, a relative position of the first housing to the second housing being changeable,
the first speaker is in the first housing,
the second speaker is in the second housing, and
adjustment of the sound pressure of the at least one of the first sound and the second sound by the first speaker or the second speaker corresponds to a change in the relative position.

14. The electronic device of claim 1, wherein
the housing includes an inner surface which faces a respective speaker among the first speaker and the second speaker and defines the audio passage,
the respective speaker includes a speaker surface facing the inner surface of the housing, and
the inner surface of the housing is inclined with respect to the speaker surface.

15. An electronic device comprising:
an audio passage which is exposed to outside of the electronic device;
a first speaker which is in audio connection with the audio passage;
a processor; and
a memory which is operatively connected to the processor and stores a first instruction executable by the processor,
wherein the first instruction which is executed includes:
the first speaker outputting a first sound comprising sub sounds with different frequencies in a first frequency range and each having a sound pressure; and
the first speaker temporarily increasing the sound pressure of respective sub sounds of the first sound, at different times, in an order of the different times.

16. The electronic device of claim 15, wherein the first speaker has a first resonance frequency which corresponds to the first frequency range.

17. The electronic device of claim 15, further comprising a second speaker in audio connection with the audio passage,
wherein the first instruction which is executed further includes:
each of the first speaker and the second speaker outputting the first sound simultaneously with outputting a second sound comprising sub sounds with different frequencies in a second frequency range and each having a sound pressure; and
the each of the first speaker and the second speaker temporarily increasing the sound pressure of the respective sub sounds of the first sound and respective sub sounds of the second sound, at the different times, in the order of the different times.

18. The electronic device of claim 17, wherein
the memory further stores a second instruction executable by the processor, and
the second instruction which is executed includes the first speaker playing a sound having a frequency in an inaudible range.

19. The electronic device of any one of claim 15, further comprising a housing including an inner surface which defines the audio passage, faces the first speaker and is inclined with respect to a facing surface of the first speaker which faces the inner surface.

20. An electronic device comprising:
a housing defining an audio passage which is exposed to outside of the electronic device and along which a foreign substance is moveable both away from and toward the outside of the electronic device; and
a speaker configured to output a sound into the audio passage, the sound comprising:
a first sound corresponding to a first frequency range, and
a second sound corresponding to a second frequency range which is at least partly different from the first frequency range, for a time period,
wherein the speaker simultaneously outputting the first sound and the second sound for the time period both corresponds to the foreign substance being in the audio passage or being in proximity to the speaker along the audio passage and moves the foreign substance which is in the audio passage or is in proximity to the speaker along the audio passage and toward the outside of the electronic device.
